(19) United States
(12) Patent Application Publication
(10) Pub. No.: US 2014/0161957 A1
(43) Pub. Date: Jun. 12, 2014

(54) BETA STRUCTURED ROLL-IN SHORTENING COMPOSITION

(71) Applicants: Nuria C. Acevedo, Drumbo (CA); Alejandro G. Marangoni, Guelph (CA)

(72) Inventors: Nuria C. Acevedo, Drumbo (CA); Alejandro G. Marangoni, Guelph (CA)

(73) Assignee: UNIVERSITY OF GUELPH, Guelph, ON (CA)

(21) Appl. No.: 14/122,846

(22) PCT Filed: May 30, 2012
(86) PCT No.: PCT/CA2012/050356

§ 371 Date: Feb. 19, 2014

Related U.S. Application Data
(60) Provisional application No. 61/491,299, filed on May 30, 2011.

(51) Int. Cl. A23D 9/007

(52) U.S. Cl. CPC A23D 9/007
USPC 426/601; 426/519

(57) ABSTRACT

The present invention provides a non-interesterified fully hydrogenated oil:oil:emulsifier composition crystallized to beta polymorphic structure having less than 5% trans-fats. The shortening composition can be used as a shortening and as a roll-in shortening for manufacture of laminated dough products such as croissants and Danishes.

### CROSS-REFERENCE TO RELATED APPLICATIONS

This application claims priority from U.S. provisional patent application 61/491,299 filed on May 30, 2011 and herewith incorporated in its entirety.

### FIELD OF THE INVENTION

The present invention relates to a novel non-interesterified, beta polymorphic form roll-in shortening that can provide no trans-fats products. More specifically, the roll-in shortening can be used in the process of baking laminated dough products.

### BACKGROUND OF THE INVENTION

Roll-in shortening is used to create laminated dough used in the manufacture of products such as croissants and Danishes. The shortening has to withstand enormous pressures and create a barrier between dough layers, which then expand upon evaporation of water during baking and create the puff pastry appearance.

Shortenings suitable for laminated dough application can be prepared from selected partially hydrogenated (high-trans fat content) vegetable oils, such as Bunge Anhydrous Puff Pastry Shortening O/U, Formula ID: F597X (Bunge Oils, Bradley, II, USA). Anhydrous puff pastry shortenings are processed for exceptional plasticity and are specifically designed for making high-volume, flaky puff pastry and Danish or croissant pastry products. To achieve the mechanical properties, melting temperatures and yield stress required, traditional shortenings are compositions in beta prime polymorphic form, with small fat crystal sizes, and have been traditionally made from partially hydrogenated oil, blends of partially hydrogenated oils, and/or blends of palm oil fractions. Partially hydrogenated oil and oil combination provides the required plastic characteristics of a roll-in shortening.

Hydrogenation has been used for many years for the production of margarine and shortenings. The process of hydrogenation of an oil is based in the addition of hydrogen atoms to unsaturated fats, eliminating double bonds and making them into partially or completely saturated fats. Hydrogenation can serve either or both of two important functions. First, it can be used to improve the flavor stability and keeping qualities of an oil, especially by reducing or removing the content of highly reactive linolenic acid, thus preventing much of the oxidative rancidity and off-flavor development that might otherwise occur. Second, hydrogenation can change the physical character of an oil by converting it from a liquid into a semisolid, plastic fat, closely resembling butter or lard in texture, and suitable for use in making margarine or butter. One of the problems arising from the hydrogenation process is the generation of trans-fatty acids.

In general unsaturated fatty acids in fats and oils have double bonds in a cis configuration. The relatively high temperatures and heterogeneous catalyst used in the hydrogenation process tend to catalyze the conversion of some of the carbon-carbon double bonds into the trans form. If these particular bonds are not hydrogenated during the process, they will be present as trans-fats in the final product.

Examples of satisfactory shortening products contain both high levels of trans-fats and saturated fats. The presence of trans-fats in shortening contributes to an unhealthy diet and increases the prevalence of heart disease and metabolic disorders. Further, the World Health Organization (WHO) has resolved that trans fats and excessive consumption of saturated fats negatively affect cholesterol profiles, predisposing individuals to heart disease, and recommends avoiding saturated fats in order to reduce the risk of a cardiovascular disease.

In order to make a plastic fat, a mixture of hard fat and oil is required. With the health risks of partially hydrogenated fats, the options available commercially to make plastic fats have been reduced to the use of palm oil and palm oil fractions, animal fats (tallow, lard, milk fat) and fully hydrogenated oils from soybean and canola predominantly. The use of fully hydrogenated fats mixed with liquid oils has also required chemical and/or enzymatic interesterification to modify physical properties so as to resemble a traditional shortening (beta prime crystal structure, small crystal sizes, and a more gradual melting profile). Recently palm oil and blends of oils with palm stearin have been used for this purpose. Enzymatically (or chemically) interesterified shortenings, such as ADM's products have attempted to use fully hydrogenated stock and oil mixture. However, palm oils have a high saturated fat content between 45-60%, detrimental to cardiovascular health. Moreover, some recent concerns about interesterified fats have cast doubts on the future use of this technology.

It would be beneficial for a non-interesterified composition to be developed comprising reduced trans-fats and saturated fats suitable for use as a roll-in shortening. It would also be beneficial to provide a product where the hydrogenated oil used is not trans-esterified. It would further be beneficial to provide a product which does not contain palm oil.

### SUMMARY OF THE INVENTION

The present invention provides a roll-in shortening having a fully hydrogenated oil (which has not been interesterified), an oil and an emulsifier, especially designed for use in the preparation of laminated dough products, especially those having a low or no-trans fat content. The shortening is a low-trans fat product. Its small-sized crystals present a beta polymorphism.

In a first aspect, the present invention provides a shortening composition comprising (a) between 8.500 to 39.995% (w/w) of a fully hydrogenated oil, (b) between 58.500 to 89.995% of an oil; and (c) between 0.01 to 3% of an emulsifier. The shortening composition has less than 5% trans fatty acids. In addition, its crystals exhibit a beta polymorphism.

In an embodiment, the fully hydrogenated oil content is between about 18.500 and about 39.995%. In another embodiment, the fully hydrogenated oil content is between about 29.500 and about 29.995% of the fully hydrogenated oil. In another embodiment, the fully hydrogenated oil can be a fully hydrogenated vegetable oil such as, for example, a fully hydrogenated soybean oil, a fully hydrogenated cottonseed oil, a fully hydrogenated canola oil, a fully hydrogenated sunflower oil, a fully hydrogenated safflower oil, a fully hydrogenated colza oil, a fully hydrogenated corn oil, a fully hydrogenated peanut oil, a fully hydrogenated olive oil, a fully hydrogenated microalgae oil, a fully hydrogenated rice bran oil as well as combinations thereof. In yet another embodiment, the fully hydrogenated vegetable oil is a fully hydrogenated soybean oil. In yet a further embodiment, the fully hydrogenated oil is a fully hydrogenated fish oil.

In an embodiment, the oil content is between about 58.500 and about 79.995%. In another embodiment, the oil content is between about 68.500 to about 69.995%. In another embodiment, the oil can be a vegetable oil, such as, for example, a soybean oil, a cottonseed oil, a canola oil, a sunflower oil, a safflower oil, a colza oil, a corn oil, a peanut oil, an olive oil, a microalgae oil, a rice bran oil as well as combinations thereof. In still another embodiment, the vegetable oil has a high oleic acid content. Exemplary high oleic acid oil include, but are not limited to a high oleic-low linoleic/linolenic sunflower oil, a high oleic-low linoleic/linolenic canola oil, a high oleic-low linoleic/linolenic soybean oil, a high oleic-low linoleic/linolenic safflower oil, a high oleic-low linoleic/linolenic microalgae oil, a high oleic-low linoleic/linolenic sunflower oil as well as combination thereof. In yet another embodiment, the vegetable oil is a soybean oil. In yet a further embodiment, the oil is a fish oil.

In an embodiment, the emulsifier content is 3%. In another embodiment, the emulsifier content is 1%. In some embodiments, the emulsifier can be sorbitan monostearate, polyoxyethylenesorbitan monostearate, glyceryl monopalmitate, sorbitan monopalmitate, sodium stearoyl lactylate, phosphatidylcholine, a combination of mono- and di-glycerides from an hydrogenated palm as well as combinations thereof. In still another embodiment, the emulsifier is glyceryl monopalmitate.

In yet another embodiment, the shortening composition has about 28.500% of the fully hydrogenated oil, about 68.500% of the oil and about 1% of the emulsifier. In this particular embodiment, the fully hydrogenated oil is a fully hydrogenated soybean oil, the oil is a soybean oil and the emulsifier is glyceryl monopalmitate.

The present invention also provides a process for making the shortening composition defined herein. Broadly the process first comprises providing the appropriate amount of each of the shortening components (such as, for example, providing a combination having between about 8.500 to 39.995% (w/w) of a fully hydrogenated oil; between 58.500 to 89.995% of an oil; and between 0.01 to 3% of an emulsifier). In an embodiment, the process also comprises mixing the components of the shortening composition to provide a first mixture. The temperature of this first mixture is then adjusted, under agitation, to between about −5° C. to about 20° C. (preferably between about −5° C. to about 10° C. and even more preferably between about −5° C. to about 5° C., between about −5° C. to about 0° C. or between about −2° C. to about 2° C.) to obtain a second mixture. The temperature of this second mixture is then adjusted (optionally under agitation) to a temperature between about 8° C. to 15° C. (preferably between about 8° C. to about 15° C., more preferably between about 8° C. to about 10° C. and even more preferably between about 10° C. to about 13° C.). In an embodiment, the process further comprising adjusting, under agitation, the temperature of the first mixture to between about 5° C. to about 15° C. (preferably between about 8° C. to about 10° C.) prior to providing the second mixture. In some embodiments, a scraped surface chiller can be used to provide agitation.

### BRIEF DESCRIPTION OF THE DRAWINGS

A detailed description of the preferred embodiments are provided herein below by way of example only and with reference to the following drawings.

FIG. 1 illustrates the functionality as a roll-in shortening of compositions comprising fully hydrogenated oil, oil with and without an emulsifier in accordance with the preferred embodiment of the present invention as shown in Table 2. Panel A provides a measure of yield stress (in Pa) in function of ΔSₘ (in J mol⁻¹K⁻¹) for various shortening composition described in Table 1. Panel B provides a measure of yield stress (in Pa) in function of ΔSₘ (in J mol⁻¹K⁻¹) is a close-up of the shortening having a yield stress of less than 900 Pa (and considered as functional).

FIG. 2 illustrates solid fat content profiles (SFC in %) in function of temperature for various fat mixtures in the absence of emulsifier. Panel A provides the results for a 40% FHSO/60% SO fat mixture crystallized using the AB () or the ABC configuration (▪); panel B provides the results for a 30% FHSO/70% SO fat mixture crystallized with the AB (), the ABC (▪) or the ACB configuration (▴); panel C provides the results for a 20% FHSO/80% SO fat mixture crystallized using the AB (▪), the ABC () or the ACB configuration (∇); panel D provides the results for the Bunge APPS fat mixture; panel E provides the results for the 40% FHSO/60% SO fat mixture (▪), the 30% FHSO/70% SO fat mixture (▴) or the 20% FHSO/80% SO fat mixture all crystallized using the ABC configuration (▾).

FIG. 3 illustrates solid fat content profiles (SFC in %) in function of temperature (° C.) obtained for fat mixtures with 30:70 proportions of FHSO and SO respectively, crystallized using the ABC configuration, in the presence or absence of 1% or 3% of different emulsifiers. Panel A presents the results obtained using 1% emulsifier, whereas panel B presents the results obtained using 3% emulsifier. In these two panels, the following emulsifiers were used glyceryl monostearate (GMS), sodium stearoyl lactylate (SSL), polyglycerol monostearate (PGMS), phosphatidylcholine (P-CHOLINE), mono- and di-glycerides from hydrogenated palm oil (BFP®), glyceryl monopalmitate (GMP), sorbitan monopalmitate (SMP) or sorbitan monostearate (SMS).

FIG. 4 illustrates solid fat content profiles (SCF in %) in function of temperature (° C.) obtained for fat mixtures with 30:70 proportions of FHSO and SO respectively, crystallized using the ACB configuration, in the presence or absence of 1% or 3% of different emulsifiers. Panel A presents the results obtained using 1% emulsifier, whereas panel B presents the results obtained using 3% emulsifier. In these two panels, the following emulsifiers were used glyceryl monostearate (GMS), sodium stearoyl lactylate (SSL), polyglycerol monostearate (PGMS), phosphatidylcholine (P-CHOLINE), mono- and di-glycerides from hydrogenated palm oil (BFP®), glyceryl monopalmitate (GMP) or sorbitan monopalmitate (SMP).

FIG. 5 illustrates solid fat content profiles (SCF in %) in function of temperature (° C.) obtained for fat mixtures with 20:80 proportions of FHSO and SO respectively, in the presence or absence of 1% or 3% of different emulsifiers. Panel A presents the results obtained using 1% or 3% emulsifier using the ABC configuration. Panel B presents the results obtained using 1 or 3% emulsifier using the ACB configuration. In these two panels, the following emulsifiers were used glyceryl monostearate (GMS), sodium stearoyl lactylate (SSL), sorbitan monostearate (SMS) or polyglycerol monostearate (PGMS).

FIG. 6 illustrates solid fat content profiles (SCF in %) in function of temperature (° C.) obtained for fat mixtures with 10:90 proportions of FHSO and SO respectively, in the presence or absence of various emulsifiers. Panel A presents the results obtained using no emulsifier, 1% SSL, 3% SSL, 1% GMS or 3% GMS for fat mixtures crystallized using the ACB configuration. Panel B presents the results obtained using no emulsifier, 1% SSL or 3% SSL for fat mixtures crystallized using the AB, ABC or ACB configuration. Panel C presents the results obtained using no emulsifier or 1% GMS for fat mixtures crystallized using the AB, ABC or ACB configuration. Panel D presents the results obtained using no emulsifier, 1% SSL or 1% GMS for fat mixtures crystallized using the ACB configuration.

FIG. 7 illustrates the melting temperature (Tₘ in ° C.) for Bunge APPS (control shortening) and fat mixtures with different proportions of FHSO and SO in the absence of an emulsifier. Results are shown for fat mixtures with 40:60 FSHO and SO respectively (crystallized using the AB or ABC configuration), with 30:70 FSHO and SO respectively (crystallized using the AB, ABC or ACB configuration), with 20:80 FSHO and SO respectively (crystallized using the AB, ABC or ACB configuration), with 10:90 FSHO and SO respectively (crystallized using the ACB configuration) or for Bunge APPS.

FIG. 8 illustrates the melting temperature (Tₘ in ° C.) for Bunge APPS (control shortening) and fat mixtures with 30:70 of FHSO and SO respectively, crystallized using the ABC (panel A) or ACB (panel B) configurations. Results are shown for fat mixtures obtained in the absence of an emulsifier, with 1% GMS, 1 or 3% SSL, 1 or 3% PGMS, 1 or 3% P-CHOLINE, 1 or 3% BFP®, 1 or 3% SMP or Bunge APPS.

FIG. 9 illustrates the melting temperature (Tₘ in ° C.) for Bunge APPS (control shortening) and fat mixtures with 20:80 of FHSO and SO respectively, crystallized using the ABC (panel A) or ACB (panel B) configurations in the presence or absence of an emulsifier. Results are shown for fat mixtures obtained in the absence of an emulsifier, with 1% or 3% GMS, 1 or 3% SSL, 1 or 3% PGMS, 1 or 3% SMS or Bunge APPS.

FIG. 10 illustrates the melting temperature (Tₘ in ° C.) for Bunge APPS (control shortening) and fat mixtures with 10:90 of FHSO and SO respectively. Results are shown for fat mixtures obtained using the AB configuration (1% GMS, 1 or 3% SSL), the ABC configuration (1 or 3% GMS, 1 or 3% SSL as well as in the absence of an emulsifier), the ACB configuration (1 or 3% GMS, 1 or 3% SSL) or Bunge APPS.

FIG. 11 illustrates the melting enthalpy (ΔHₘ in J/g) obtained for the control shortening (Bunge APPS) and fat mixtures with different proportions of FHSO and SO respectively, in the absence of an emulsifier. Results are shown for fat mixtures with 40:60 FSHO and SO respectively (crystallized using the AB or ABC configuration), with 30:70 FSHO and SO respectively (crystallized using the AB, ABC or ACB configuration), with 20:80 FSHO and SO respectively (crystallized using the AB, ABC or ACB configuration), with 10:90 FSHO and SO respectively (crystallized using the ACB configuration) or for Bunge APPS.

FIG. 12 illustrates the melting enthalpy (ΔHₘ in J/g) obtained for the control shortening (Bunge APPS) and fat mixtures with 30:70 of FHSO and SO respectively, crystallized using the ABC (panel A) or ACB (panel B) configurations. Results are shown for fat mixtures obtained in the absence of an emulsifier, with 1% GMS, 1 or 3% SSL, 1 or 3% PGMS, 1 or 3% P-CHOLINE, 1 or 3% BFP®, 1 or 3% SMP or Bunge APPS.

FIG. 13 illustrates the melting enthalpy (ΔHₘ in J/g) obtained for the control shortening (Bunge APPS) and fat mixtures with 20:80 proportions of FHSO and SO respectively, crystallized using the ABC (panel A) or ACB (panel B) configurations in the presence or absence of an emulsifier. Results are shown for fat mixtures obtained in the absence of an emulsifier, with 1% or 3% GMS, 1 or 3% SSL, 1 or 3% PGMS, 1 or 3% SMS or Bunge APPS.

FIG. 14 illustrates the melting enthalpy (ΔHₘ in J/g) obtained for the control shortening (Bunge APPS) and fat mixtures with 10:90 of FHSO and SO respectively. Results are shown for fat mixtures obtained using the AB configuration (1% GMS, 1 or 3% SSL), the ABC configuration (1 or 3% GMS, 1 or 3% SSL as well as in the absence of an emulsifier), the ACB configuration (1 or 3% GMS, 1 or 3% SSL) or Bunge APPS.

FIG. 15 illustrates X-ray patterns obtained for the control shortening (Bunge APPS) in the wide angle region (panel A) and small angle region (panel B). Results for the intensity are provided in function of the diffraction angle.

FIG. 16 illustrates a representative X-ray pattern in the wide angle region obtained for all the samples crystallized using the scraped surface heat exchanger. Results for the intensity are provided in function of the diffraction angle.

FIG. 17 illustrates domain size values (in angstroms) obtained for the control shortening (Bunge APPS) and various fat mixtures in the absence of an emulsifier. Results are shown for fat mixtures with 40:60 of FHSO and SO respectively (crystallized using the AB or ABC configuration); fat mixtures with 30:70 of FHSO and SO respectively (crystallized using the AB, ABC or ACB configuration); fat mixtures with 20:80 of FHSO and SO respectively (crystallized using the AB, ABC or ACB configuration); fat mixtures with 10:90 FSHO and SO respectively (crystallized using the ACB configuration) or for Bunge APPS.

FIG. 18 illustrates domain size values (in angstroms) obtained for the control shortening (Bunge APPS) and fat mixtures with 30:70 proportions of FHSO and SO respectively, in the presence or absence of an emulsifier and crystallized using the ABC (panel A) or ACB (panel B) configurations. Results are shown for fat mixtures that do no contain an emulsifier, with 1% GMS, 1 or 3% SSL, for 3% PGMS, 1 or 3% P-CHOLINE, 1% or 3% BFP®, 1 or 3% GMP, 1 or 3% SMP or Bunge APPS.

FIG. 19 illustrates domain size values (in angstroms) obtained for the control shortening (Bunge APPS) and fat mixtures with 20:80 proportions of FHSO and SO respectively, in the presence or absence of a an emulsifier and crystallized using the ABC (panel A) or ACB (panel B) configurations. Results are shown for fat mixtures that do no contain an emulsifier, with 1% GMS, 1 or 3% SSL, 1 or 3% PGMS, 1 or 3% SMS or Bunge APPS.

FIG. 20 illustrates domain size values (in angstroms) obtained for the control shortening (Bunge APPS) and fat mixtures with 10:90 proportions of FHSO and SO respectively, in the presence or absence of an emulsifier. Results are shown for fat mixtures crystallized with the AB configuration (with 1% GMS, 1 or 3% SSL), the ABC configuration (with 1 or 3% GMS, 1 or 3% SSL or in the absence of an emulsifier) or the ACB configuration (with 1 or 3% GMS, 1 or 3% SSL) or for Bunge APPS.

FIG. 21 illustrates microstructural elements of the Bunge shortening (panel A) and a fat mixture (panel B) crystallized in the scraped surface heat exchanger. Scale bar=100 μm.

FIG. 22 illustrates equivalent diameter values (in μm) for the control shortening (Bunge APPS) and different fat mixtures. Panel A provides equivalent diameter values for fat mixtures obtained in the absence of an emulsifier with 40:60 FSHO and SO respectively (crystallized using the AB or ABC configuration); with 30:70 FSHO and SO respectively (crystallized using the AB, ABC or ACB configuration); with 20:80 FSHO and SO respectively (crystallized using the AB, ABC or ACB configuration); with 10:90 FSHO and SO respectively (crystallized using the ACB configuration) or for Bunge APPS. Panel B provides equivalent diameter values in fat mixtures with 10:90 FHSO:SO proportions, in the presence or absence of an emulsifier. Results are shown for fat mixtures crystallized using the AB configuration (1% GMS, 1 or 3% SSL); the ABC configuration (1 or 3% GMS, 1 or 3% SSL or in the absence of an emulsifier) or the ACB configuration (1 or 3% GMP, 1 or 3% SSL) or for Bunge APPS.

FIG. 23 illustrates equivalent diameter values (in μm) for the control shortening (Bunge APPS) and fat mixtures with 30:70 proportions of FHSO and SO respectively, crystallized with the ABC (panel A) or ACB (panel B) configurations. Results are shown for fat mixtures that do not contain an emulsifier, with 1% GMS, 1 or 3% SSL, 1 or 3% PGMS, 1 or 3% P-CHOLINE, 1 or 3% BFP®, 1 or 3% GMP, 1 or 3% SMP or for Bunge APPS.

FIG. 24 illustrates equivalent diameter values (in μm) for the control shortening (Bunge APPS) and fat mixtures with 20:80 proportions of FHSO and SO respectively, crystallized using the ABC (panel A) or the ACB (panel B) configurations. Results are shown for fat mixtures that do not contain an emulsifier, with 1 or 3% GMS, 1 or 3% SSL, 1 or 3% PGMS, 1 or 3% SMS or for Bunge APPS.

FIG. 25 provides four representative CRYO-TEM images showing the nano-structure of the control shortening (Bunge APPS). Scale bar=200 nm.

FIG. 26 provides four representative of CRYO-TEM images showing the nano-structure of the 30:70 (w/w) FHSO:SO sample containing 1% GMP, crystallized in the votator.

FIG. 27 illustrates nano-platelet equivalent diameters (in nm) for the control shortening (Bunge APPS) and various fat mixtures. Results are provided for fat mixtures with 20:80 proportions of FHSO and SO respectively (crystallized using the ABC, AB or ACB configuration); with 40:60 proportions of FHSO and SO respectively (crystallized using the ABC configuration); with 30:70 proportions of FHSO and SO respectively (crystallized using the ABC configuration); with 20:80 proportions of FHSO and SO respectively (crystallized using the ABC configuration) or for the control shortening. Error bars are displayed in the graph however the value is low and therefore they are not visible in the graph.

FIG. 28 illustrates nano-platelet equivalent diameters (in nm) for the control shortening and various fat mixtures. Panel A provides results for fat mixtures with 30:70 proportions of FHSO and SO respectively, crystallized using the ABC configuration in the absence or presence of 1% emulsifier (GMS, SSL, PGMS, BFP®, GMP, SMP, SMS) or for the control shortening. Panel B provides results for fat mixtures with 20:80 proportions of FHSO and SO crystallized using the AB configuration (in the absence of an emulsifier or 3% GMS), the ABC configuration (in the absence of an emulsifier), the ACB configuration (with 1% GMS or in the absence of an emulsifier) or for the control shortening. Error bars are displayed in the graph however the value is low and therefore they are not visible in the graph.

FIG. 29 illustrates the storage moduli (Log G′ in MPa) obtained for the control shortening (Bunge APPS) and fat mixtures in the absence of an emulsifier. Results are shown for fat mixtures with 40:60 proportions of FHSO and SO respectively (crystallized using the AB or ABC configuration); with 30:70 proportions of FHSO and SO respectively (crystallized using the AB, ABC or ACB configuration); with 20:80 proportions of FHSO and SO respectively (crystallized using the AB, ABC or ACB configuration); with 10:90 proportions of FHSO and SO respectively (crystallized using the ACB configuration) or for the control shortening.

FIG. 30 illustrates the storage moduli (Log G′ in MPa) obtained for the control shortening (Bunge APPS) and various fat mixtures with 30:70 of FHSO and SO respectively. Panel A provides results for fat mixtures obtained using the ABC configuration, in the absence or presence of an emulsifier (1% GMS, 1 or 3% SSL, 1 or 3% PGMS, 1 or 3% P-CHOLINE, 1 or 3% BFP®, 1 or 3% GMP, 1 or 3% SMP, 1 or 3% SMS) or for the control shortening. Panel B provides results for fat mixtures obtained using the ACB configuration, in the absence or presence of an emulsifier (1% GMS, 1 or 3% SSL, 1 or 3% PGMS, 1 or 3% P-CHOLINE, 1 or 3% BFP®, 1 or 3% GMP, 1 or 3% SMP) or for the control shortening.

FIG. 31 illustrates the storage moduli (Log G′ in MPa) obtained for the control shortening (Bunge APPS) and various fat mixtures with 20:80 of FHSO and SO respectively. Panel A provides results for fat mixtures obtained using the ABC configuration, in the absence or presence of an emulsifier (1 or 3% GMS, 1 or 3% SSL, 1 or 3% PGMS, 1 or 3% SMS) or for the control shortening. Panel B provides results for fat mixtures obtained using the ACB configuration, in the absence or presence of an emulsifier (1 or 3% GMS, 1 or 3% SSL, 1 or 3% PGMS, 1 or 3% SMS) or for the control shortening.

FIG. 32 illustrates the storage moduli (Log G′ in MPa) obtained for the sample shortening (Bunge APPS) and various fat mixtures with 10:90 of FHSO and SO respectively. Results are provides for fat mixtures obtained using the AB configuration (with 1% GMS, 1 or 3% SSL), the ABC configuration (with 1 or 3% GMS, 1 or 3% SSL) or with the ACB configuration (in the absence of an emulsifier, with 1 or 3% GMS, 1 or 3% SSL) or for the control shortening.

FIG. 33 illustrates the yield stress (σ* in Pa) obtained for the control shortening (Bunge APPS) and various fat mixtures prepared in the absence of an emulsifier. Results are shown for fat mixtures with 40:60 of FHSO and SO respectively (obtained using the AB or ABC configuration); with 30:70 of FHSO and SO respectively (obtained using the AB, ABC or ACB configuration); with 20:80 of FHSO and SO respectively (obtained using the AB, ABC or ACB configuration); with 10:90 of FHSO and SO respectively (obtained using the ACB configuration) or for the control shortening.

FIG. 34 illustrates the yield stress (σ* in Pa) obtained for the control shortening and various fat mixtures with 30:70 of FHSO and SO respectively. Panel A provides results for fat mixtures obtained using the ABC configuration, in the absence or presence of an emulsifier (1% GMS, 1 or 3% SSL, 1 or 3% PGMS, 1 or 3% P-CHOLINE, 1 or 3% BFP®, 1 or 3% GMP, 1 or 3% SMP, 1 or 3% SMS) or for the control shortening. Panel B provides results for fat mixtures obtained using the ACB configuration, in the absence or presence of an emulsifier (1% GMS, 1 or 3% SSL, 1 or 3% PGMS, 1 or 3% P-CHOLINE, 1 or 3% BFP®, 1 or 3% GMP, 1 or 3% SMP) or for the control shortening.

FIG. 35 illustrates the yield stress (σ* in Pa) obtained for the control shortening (Bunge APPS) and various fat mixtures with 20:80 of FHSO and SO respectively. Panel A provides results for fat mixtures obtained using the ABC configuration, in the absence or presence of an emulsifier (1 or 3% GMS, 1 or 3% SSL, 1 or 3% PGMS, 1 or 3% SMS) or for the control shortening. Panel B provides results for fat mixtures obtained using the ACB configuration, in the absence or presence of an emulsifier (1 or 3% GMS, 1 or 3% SSL, 1 or 3% PGMS, 1 or 3% SMS) or for the control shortening.

FIG. 36 illustrates the yield stress (σ* in Pa) obtained for obtained for the sample shortening (Bunge APPS) and various fat mixtures with 10:90 of FHSO and SO respectively. Results are provides for fat mixtures obtained using the AB configuration (with 1% GMS, 1 or 3% SSL), the ABC configuration (with 1 or 3% GMS, 1 or 3% SSL) or with the ACB configuration (in the absence of an emulsifier, with 1 or 3% GMS, 1 or 3% SSL) or for the control shortening.

FIG. 37 is a view of a votator line used to manufacture the fat mixture provided in FIG. 1.

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

The present invention provides for a novel composition comprising fully hydrogenated oil, an oil as well as an emulsifier. The shortening composition is non-interesterified and is crystallized to the beta polymorphic form. The shortening composition has application as a roll-in shortening with no trans-fats and reduced saturated fat content from traditional roll-in shortenings currently used in the food industry. In some embodiments, the shortening composition can be palm oil free, e.g. does not contain palm oil or a derivatives (or fraction) thereof.

Mixtures of fully hydrogenated oils (also referred as stocks or hardstocks), which does not contain trans fatty acids, with a liquid oil have always been considered to be waxy, with a sharp and high melting point and in the incorrect crystal form (beta) for good functionality. As shown herein, the physical properties of a non-interesterified mixture of fully hydrogenated oils with an oil are modified by addition of a specific emulsifier and crystallizing. As shown herein, the resulting mixture achieved a drastic drop in the melting point while matching the rheological properties of an optimum high-trans-fat roll-in shortening. This has been achieved while retaining the beta polymorphic form of the crystals of the original hardstock. Advantages of using a beta shortening is that polymorphic transformations will not take place in time because the shortening already is in its most stable form.

### Fully Hydrogenated Oil

In the shortening composition described herein, a fully hydrogenated oil is admixed to an oil and an emulsifier. The fully hydrogenated oil serves as a source for the formation of the crystals in the shortening composition. As used herein, the term “fully hydrogenated oil” refers to an oil which has been submitted to an hydrogenation process until all the double bounds of the carbons on the fatty acid chains have been saturated with hydrogen. In the context of the present invention, the fully hydrogenated oil has not been submitted to an interesterification reaction (either chemical or enzymatic).

The content of the fully hydrogenated oil in the shortening composition varies between about 10 to about 40% (w/w), the balance of the shorting composition being essentially the oil and the emulsifier. As used herein, the term “about” and “essentially” indicates that the weight percentage of the fully hydrogenated oil:oil varies in function of the amount of emulsifier that is being added to the shortening composition. In order to produce the shortening composition as presented in the Figures and Examples, a first mixture of the fully hydrogenated oil:oil is prepared, an amount corresponding to the weight of the emulsifier is removed from the first mixture and replaced by the appropriate amount of the emulsifier. For example, when it is indicated that a 30:70 with 1% emulsifier shortening composition has been produced, a first mixture of 30% of a fully hydrogenated oil and 70% of an oil has been prepared, 1% of the first mixture has been removed and replaced by an corresponding quantity of an emulsifier. The final content of the fully hydrogenated oil in this exemplary embodiment is thus 29.500%. As such, the concentration of the fully hydrogenated oil in the shortening composition is at least about 8.500%, at least about 18.500%, at least about 28.500% or at least about 38.500%. The concentration of the fully hydrogenated oil in the shortening composition is at the most about 39.995%, at the most about 29.995%, at the most about 19.995% or at the most about 9.995%. In an embodiment, the concentration of the fully hydrogenated oil in the shortening composition is between about 8.500% and about 39.995%, between about 8.500% and about 29.995%, between about 8.500% and about 19.995% or between about 8.5% and about 9.995%. In another embodiment, the concentration of the fully hydrogenated oil in the shortening composition is between about 18.5% and about 39.995%, between about 18.5% and about 29.995% or between about 18.5% and about 19.995%. In still another embodiment, the concentration of the fully hydrogenated oil in the shortening composition is between about 28.5% and about 39.995% or between about 28.5% and about 29.995%. In still a further embodiment, the concentration of the fully hydrogenated oil in the shortening composition is between about 38.5% and about 39.995%. In still another embodiment, the concentration of the fully hydrogenated oil in the shortening composition is about 8.5%, about 9.995% (or 10%), about 18.5%, about 19.995% (or 20%), about 28.5%, about 29.995% (or 30%), about 38.5% or about 39.995% (or 40%).

For example, when the shortening composition is used as an all purpose shortening, a combination of about 20% of the fully hydrogenated oil and about 80% of an oil can advantageously be used. As another example, when the shortening composition is used as a roll-in shortening, a combination of about 30% of the fully hydrogenated oil and about 70% of the oil has been shown to be advantageous. For applications requiring a harder composition, a combination of about 40% of the fully hydrogenated oil and about 60% of the oil can be used.

The fully hydrogenated oil used is preferably prepared from a highly saturated oil.

In an embodiment, the fully hydrogenated oil is prepared from a vegetable oil, such as, for example, a liquid vegetable oil. The vegetable oils from which the fully hydrogenated oil can be prepared include, but are not limited to, soybean oil, canola oil, sunflower oil, cottonseed oil, safflower oil, colza oil, corn oil, peanut oil, olive oil, microalgae oil, rice bran oil as well as combination thereof. In an embodiment, the vegetable oil has a high oleic acid content. In some embodiment, the vegetable oil does not contain (is devoid or free of) a palm oil, a palm oil extract, a palm oil fraction or a palm oil derivative. In other embodiments, the vegetable oil is a palm oil or a palm oil fraction (such as, for example, palm stearin, palm olein, palm superolein or palm kernel oil). In still another embodiment, the vegetable oil is a fractionated fat. The vegetable oil is preferably a canola oil, a soybean oil or a combination thereof and, more preferably, a soybean oil.

In a further embodiment, the fully hydrogenated oil can also be prepared from a fish oil.

### Oil

In the shortening composition described herein, an oil is admixed with a fully hydrogenated oil and an emulsifier. The oil serves as a solvent for the crystallization process and the resulting crystals. As used herein, the term “oil” refers to an oil which has not been submitted to an hydrogenation process or to a interesterification process. As it will be discussed below, the oil can be submitted to a fractionation process.

The content of the oil in the shortening composition varies between about 60 to about 90% (w/w), the balance of the shorting composition being essentially the fully hydrogenated oil and the emulsifier. As used herein, the term “about” and “essentially” indicates that the weight percentage of the fully hydrogenated oil:oil varies in function of the amount of emulsifier that is being added to the shortening composition. In order to produce the shortening composition as presented in the Figures and Examples, a first mixture of the fully hydrogenated oil:oil is prepared, an amount corresponding to the weight of the emulsifier is removed from the first mixture and replaced by the appropriate amount of the emulsifier. For example, when it is indicated that a 30:70 with 1% emulsifier shortening composition has been produced, a first mixture of 30% of a fully hydrogenated oil and 70% of an oil has been prepared, 1% of the first mixture has been removed and replaced by an corresponding quantity of an emulsifier. The final content of the oil in this exemplary embodiment is thus 69.5%. As such, the concentration of the oil in the shortening composition is at least about 58.5%, at least about 68.5%, at least about 78.5% or at least about 88.5%. The concentration of the oil in the shortening composition is at the most about 89.995%, at the most about 79.995%, at the most about 69.995% or at the most about 59.995%. In an embodiment, the concentration of the oil in the shortening composition is between about 58.5% and about 89.995%, between about 58.5% and about 79.995%, between about 58.5% and about 69.995% or between about 58.5% and about 59.995%. In another embodiment, the concentration of the oil in the shortening composition is between about 68.5% and about 89.995%, between about 68.5% and about 79.995% or between about 68.5% and about 69.995%. In still another embodiment, the concentration of the oil in the shortening composition is between about 78.5% and about 89.995% or between about 78.5% and about 79.995%. In still a further embodiment, the concentration of the oil in the shortening composition is between about 88.5% and about 89.995%. In still another embodiment, the concentration of the oil in the shortening composition is about 58.5%, about 59.995% (or 60%), about 68.5%, about 69.995% (or 70%), about 78.5%, about 79.995% (or 80%), about 88.5% or about 89.995% (or 90%).

For example, when the shortening composition is used as an all purpose shortening, a combination of about 20% of the fully hydrogenated oil and about 80% of an oil can advantageously be used. As another example, when the shortening composition is used as a roll-in shortening, a combination of about 30% of the fully hydrogenated oil and about 70% of the oil has been shown to be advantageous. For applications requiring a harder composition, a combination of about 40% of the fully hydrogenated oil and about 60% of the oil can be used.

The oil used is preferably a highly saturated oil. Alternatively or complementarily, the oil can be an oil containing a high oleic acid content.

In an embodiment, the oil is a vegetable oil, such as, for example, a liquid vegetable oil. The vegetable oils include, but are not limited to, soybean oil, canola oil, sunflower oil, cottonseed oil, safflower oil, colza oil, corn oil, peanut oil, olive oil, microalgae oil, rice bran oil as well as combination thereof. In an embodiment, the vegetable oil has a high oleic acid content and/or a low linoleic/linolenic content (such as, for example, a high oleic-low linoleic/linolenic sunflower oil, a high oleic-low linoleic/linolenic canola oil, a high oleic-low linoleic/linolenic soybean oil, a high oleic-low linoleic/linolenic safflower oil and/or a high oleic-low linoleic/linolenic sunflower oil). In some embodiment, the vegetable oil does not contain (is devoid or free of) a palm oil, a palm oil extract, a palm oil fraction or a palm oil derivative. In other embodiments, the vegetable oil is a palm oil or a palm oil fraction (such as, for example, palm stearin, palm olein, palm superolein or palm kernel oil). In still another embodiment, the vegetable oil is a fractionated fat. The vegetable oil is preferably a canola oil, a soybean oil or a combination thereof and, more preferably, a soybean oil.

In a further embodiment, the oil can also be (or include) a fish oil.

### Emulsifier

In the shortening composition described herein, an emulsifier is admixed to a fully hydrogenated oil and an oil. The emulsifier serves to modify and manipulate the interactions between the fat crystals and the size of those crystals which will in turn alter the physical properties of the product, such as oil binding capacity and firmness. Destabilization of the crystalline lattice by an emulsifier allows for lowering of the melting point, for lowering the hardness as well as modifying the rheological properties of the final product. As used herein, the term “emulsifier” (also known as an emulgent) refers to a substance capable of stabilizing an emulsion by increasing its kinetic stability. Without wishing to be bound to theory, it is taught that, in some embodiments, the emulsifier can co-crystallize with the fully hydrogenated oil, affect the packing of the fully hydrogenated oil molecules which would ultimately lead to changes in crystallization behaviour (for example crystal size and/or aggregation behaviour). It is taught that, in some embodiments, the crystalline lattice destabilization can lead to a decrease in the melting point of the final product. It is also taught that, in some embodiments, the emulsifier can affect the intercrystalline interactions.

The content of the emulsifier in the shortening composition can vary between about 0.01 to about 3% (w/w), the balance of the shorting composition being essentially a combination of the fully hydrogenated oil and the oil. In an embodiment, the emulsifier concentration is at least about 0.01%, at least about 0.05%, at least about 0.1%, at least about 0.25%, at least about 0.5%, at least about 1.0%, at least about 2.0% or at least about 3.0%. In another embodiment, the emulsifier concentration is at the most about 3.0%, at the most about 2.0%, at the most about 1.0%, at the most about 0.5%, at the most about 0.25%, at the most about 0.1%, at the most about 0.05% or at the most about 0.01%. In still another embodiment, the concentration of the emulsifier is between about 0.01% and about 0.05%, about 0.01% and about 0.1%, about 0.01% and about 0.25%, about 0.01% and about 0.5%, about 0.01% and about 1.0%, about 0.01% and about 2.0% or about 0.01% and about 3.0%. In yet another embodiment, the concentration of the emulsifier is between about 0.05% and about 0.1%, about 0.05% and about 0.25%, about 0.05% and about 0.5%, about 0.05% and about 1.0%, about 0.05% and about 2.0% or about 0.05% and about 3.0%. In still a further embodiment, the concentration of the emulsifier is between about 0.1% and about 0.25%, about 0.1% and about 0.5%, about 0.1% and about 1.0%, about 0.1% and about 2.0% or about 0.1% and about 3.0%. In yet a further embodiment, the concentration of the emulsifier is between about 0.25% and about 0.5%, about 0.25% and about 1.0%, about 0.25% and about 2.0% or about 0.25% and about 3.0%. In a further embodiment, the concentration of the emulsifier is between about 0.5% and about 1.0%, about 0.5% and about 2.0% or about 0.5% and about 3.0%. In still a further embodiment, the concentration of the emulsifier is between about 1.0% and about 2.0% or about 1.0% and about 3.0%. In another embodiment, the concentration of the emulsifier is between about 2.0% and about 3.0%. In still another embodiment, the concentration of the emulsifier is about 0.01%, about 0.05%, about 0.1%, about 0.25%, about 0.5%, about 1.0%, about 2.0% or about 3.0%. Preferably, the concentration of the emulsifier is about 1% or about 3%.

The emulsifier can be selected from any substance known to those skilled in the art to stabilize the emulsion of the shortening composition. Such emulsifiers include, but are not limited to sorbitan monostearate (SMS or Span 60™), polyoxyethylenesorbitan monostearate (Tween 60™), glyceryl monopalmitate (GMP), sorbitan monopalmitate (SMP), sodium stearoyl lactylate (SSL), phosphatidylcholine (PChol) and/or polyglycerol monostearate (PGMS). In some embodiments, the emulsifier is low iodine number and high palmitic acid mono- and diglycerides from hydrogenated palm oil (Caravan 75 BFP™) optionally in combination with other emulsifiers. Preferably, the emulsifier is GMP.

### Process for Making the Shortening Composition

Crystallization to the beta polymorphic form under high cooling rates facilitates the production of crystal of smaller sizes, which contribute to increased functionality of the end product. Crystallization of shortening composition can occur in a container with temperature controlling means. The container may contain a scraped surface heat exchanger, said scraped surface heat exchanger making up at least 1 unit in a votator line (either A or C), as shown in FIG. 37. The votator line can also include a mixing unit (B).

In a preferred embodiment of the process of manufacturing the composition, the shortening components are first mixed and submitted to crystallization in a votator line comprising at least one scraped surface heat exchanger. The votator can comprise a holding vessel, a supply pump, a A unit (comprising a scraped surface chiller with temperature controlling means), a B unit (comprising temperature controlling and agitation means), and, optionally, a C Unit (comprising a scraped surface chiller with temperature controlling means). A and C units are equivalent, but set at different temperatures. Both units have a rotating shaft with blades that continuously scrape product film from the heat transfer tube wall, thereby enhancing heat transfer, and agitating the product to produce a homogenous mixture. The working unit B can consist of a tube, in which a motorized shaft with agitating pins revolves at a fixed speed, this unit prevents material from setting, so it can deliver a soft product to tubs or bulk containers

The components of the shortening are first melted in the vessel and kept at a temperature equal to or above the melting temperature of the composition for a time sufficient to ensure erasing of the crystal memory. An example of an appropriate temperature and time is 80° C. for 30 min.

Afterwards, the components of the shortening composition are cooled down and kept at a temperature until the onset of crystallization. An example of an appropriate cooled down temperature for the molten shortening components is between about 68° C. to about 70° C. The molten mixture is then pumped at a flow rate through the votator line. The flow rate of the votator line can be, for example, between about 30 and about 50 kg/h, preferably between about 35 to about 45 kg/h and more preferably between of about 38 to about 39 kg/h. Preferably, the tubing system between each unit and the outlets of the votator line are well-insulated to avoid/limit heat loss.

The molten shortening components are first placed in the A unit of the votator line. The A unit comprises a scraped surface heat exchanger for favouring crystallization. The temperature of the shortening component in the A unit is set to reach between about −5° C. to about 20° C., preferably between about −5° C. to about 10° C., more preferably between about −5° C. to about 5° C., even more preferably between about −5° C. to about 0° C., such as, for example, between about −2° C. to about 2° C.

In an embodiment, once the shortening components have been submitted the A unit, they can be submitted directly to B unit. Alternatively, the shortening components can be first submitted to A and C units and then to the B unit. The B unit does not provide a scraped surface heat exchanger but instead offers agitated pins for a gentler agitation. The temperature of the shortening components in the B unit is set to reach between about 8° C. to about 15° C. and preferably between about 10 to about 13° C.

In an embodiment, once the shortening components that have been submitted to the A and B units can be submitted to the C unit. Alternatively, the shortening components can be submitted directly to the C unit after they have been submitted to the A unit and prior to their submission to the B unit. Just like the A unit, the C unit comprises a scraped surface heat exchanger for favouring crystallization. The temperature of the shortening components in the C unit is set to reach between about 5° C. to about 15° C. and preferably between about 8° C. to about 10° C.

As shown herewith, different unit configurations can be used, as long as they include a step in the A unit and another one in the B unit. The shortening components can be collected directly after passing through the scraped-surface chiller unit plus the agitated working unit (configuration AB); or after the addition of an extra heat exchanger unit (unit C) before or after the working unit (configuration ACB and ABC, respectively). Preferably, a ACB configuration is used.

After crystallization the sample may, optionally, be held at about 20±5° C. for about 2 days to allow completion of the crystallization process. The product of this process can subsequently be stored under a number of conditions until use, including at room temperature or refrigerated.

While temperature and time parameters are included in the description, these are known in the art and can be modified, as is understood by a person skilled in the art.

### Shortening Composition

Traditionally it has been understood a gradual melting profile and a beta prime form is needed to have a good shortening. However, as shown herein, it is possible to obtain an functional shortening by allowing the formation of small crystals are present and designing the appropriate melting temperature. As it will be shown herewith, the shortening composition comprises a large number of stable small crystals in the beta form with a crystalline lattice that has been destabilized by an emulsifier. This method and composition allow one to forego the entire interesterification process, thereby reducing costs and losing a processing step. This also addresses consumer demands for less processed foods.

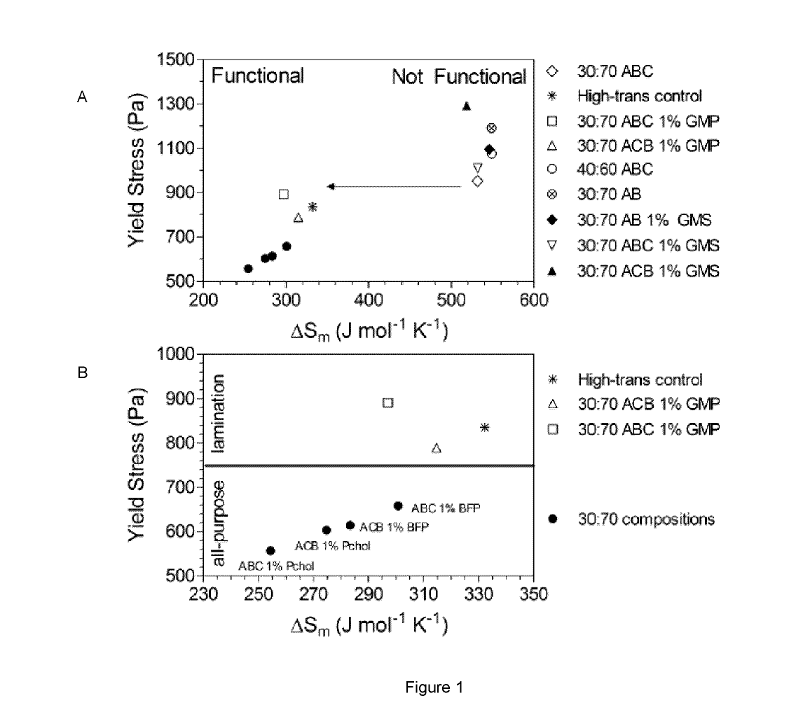

Various fat mixtures have been prepared and their characteristics are provided in Table 1. Their functionality is provided in FIG. 1.

TABLE 1
Description of various fat mixtures analysed in FIG. 1.

| | | Concen- | | |
|---|---|---|---|---|
| | Concentration | tration | | Type and |
| | (w/w) of fully | (w/w) of | Type of | concentration |
| | hydrogenated | soybean | manufacturing | (w/w) of |
| Name | soybean oil | oil | process | emulsifier |
| 30:70 | 30% | 70% | ABC | None |
| ABC | | | | |
| 30:70 % | 30% | 70% | ABC | Glyceryl |
| ABC 1 | | | | monopalmitate |
| GMP | | | | (1%) |
| 30:70 | 30% | 70% | ACB | Glyceryl |
| ACB 1% | | | | monopalmitate |
| GMP | | | | (1%) |
| 40:60 | 40% | 60% | ABC | None |
| ABC | | | | |
| 30:70 | 30% | 70% | AB | None |
| AB | | | | |
| 30:70 | 30% | 70% | AB | Glyceryl |
| AB 1% | | | | monostearate |
| GMS | | | | (1%) |
| 30:70 | 30% | 70% | ABC | Glyceryl |
| ABC 1% | | | | monostearate |
| GMS | | | | (1%) |
| 30:70 | 30% | 70% | ACB | Glyceryl |
| ACB 1% | | | | monostearate |
| GMS | | | | (1%) |

In FIG. 1A, a large difference in behaviour is noticed between functional and non-functional fats along the lines of both structural order and yield stress. Generally, a composition with a yield stress above 900 Pa and a structural order greater than 450 J/mol are considered too hard and brittle for functionality. Compositions without emulsifier and compositions with GMS generally fell in this category. Addition of surfactant, other than GMS, shifted properties from non-functional to functional. FIG. 1B is a close up of the functional region only. Within these samples, a striking linear relationship between structural order and yield stress was observed. Samples with a yield stress greater than 750 Pa were excellent laminating, roll-in shortenings. These included the high-trans-fat containing control obtained commercially as well as the 30:70 FHSO-soybean oil blends containing 1% glyceryl monopalmitate (GMP). Both ABC and ACB votator configurations provided functional shortening. What is also observed is that 30:70 compositions containing the mixture of mono and diglycerides (BFP) and phosphatidylcholine (Pchol) added as the surfactant softened the mixture to an extent where lamination was not optimal, but suddenly these samples had excellent all-purpose shortening properties. This group of emulsifiers were the ones with the greatest oil-binding capacity.

FIG. 1 clearly demonstrates the ability to engineer material properties (yield stress) upon the addition of a specific emulsifier which disrupts crystalline structural order. The yield stress-structural order phase space is a valuable tool to help engineer fat properties. It is now possible to choose or engineer fats to fall within specific regions of functionality from simple calorimetry measurements.

As shown herewith, the shortening composition obtained have unique physico-chemical properties. The shortening composition can advantageously be used as a roll-in shortening for the preparation of laminated dough product (croissant, Danishes, etc.). Alternatively, it can also be used as a general shortening and even as a spreadable product.

As indicated herein, the shortening composition comprises a combination of the fully hydrogenated oil, the oil and the emulsifier. It can also contain other additives depending on the applications. In some embodiments, the shortening composition consists of the combination of the fully hydrogenated oil, the oil and the emulsifier. In other embodiments, the shortening compositions consists essentially of the combination of the fully hydrogenated oil, the oil and the emulsifier.

An advantageous feature is that the shortening composition contains less than about 5% trans fatty acid content and can advantageously be used for the manufacture of trans fat free product. In an embodiment, the trans fatty acid content of the shortening composition is less than about 4.5%, less than about 4% or less than about 3.7%. In an embodiment, the trans fatty acid content of the shortening composition is between about 3.7% and about 4%, between about 3.7% and about 4.5% or between about 3.7% and about 5%. In yet another embodiment, the trans fatty acid content of the shortening composition is between about between about 4% and about 4.5% or between about 4% and about 5%. In still another embodiment, the trans fatty acid content of the shortening composition is between about 4% and about 5%.

In some embodiment, the shortening composition can be prepared in the absence of a palm oil, palm fraction or palm derivative.

In some embodiments, the shortening composition has been shown to be able ability to retain oil and as such as presents a low oil migration ratio. For example, the OMG can be less than 5%. In some embodiment, the OMG can be between about 0.3% and about 5%, preferably between about 1.5% and about 5% and more preferably between about 2% and about 5%. In other embodiment, the OMG can be between about 0.3% and about 4%, preferably between about 1.5% and about 4% and more preferably between about 2% and about 4%.

In other embodiment, the shortening composition has been shown to have a relatively low melting temperature. For example, its melting temperature can be below about 65° C., below about 60° C. or below about 55° C. In another example, its melting temperature can be above about 40° C. or above about 45° C. In yet another example, its melting temperature can be between about 40° C. and about 55° C., between about 40° C. and about 60° C. or between about 40° C. and about 60° C. In still another example, its melting temperature can be between about 45° C. and about 55° C., between about 45° C. and about 60° C. or between about 45° C. In some application, its melting temperature can be between about 44° C. and about 64° C., preferably about 47° C. and about 62° C. and more preferably between about 55° C. and about 61° C.

In some embodiments, the shortening composition has been shown to have a melting enthalpy (ΔHm) between about 10 J/g and about 80 J/g, preferably between about 20 J/g to about 60 J/g and even more preferably between about 30 J/g to about 60 J/g. In other embodiment, the shortening composition has been shown to have a melting enthalpy (ΔHm) of at least about 10 J/g, of at least about 20 J/g or of at least about 30 J/g. In still another embodiment, the shortening composition has been shown to have a melting enthalpy (ΔHm) of at most 80 J/g or of at most 60 J/g.

In some embodiments, the shortening composition have been shown to have a storage moduli (G′) between about 0.01 MPa and about 5 MPa, preferably between about 0.2 MPa and about 2 MPa and more preferably between about 1 MPa and about 2 MPa.

In other embodiments, the shortening composition have been shown to present a yield stress, (σ*) between about 150 Pa and about 1500 Pa, preferably between about 190 Pa and about 1300 Pa and even more preferably between about 600 Pa and about 1200 Pa.

Another advantageous features of the shortening composition is provided by the crystals present in the composition. The crystals of the shortening composition exhibit a beta polymorphism. In some embodiments, the crystals of the shortening composition have been shown to have a meso-equivalent diameter between about 0.5 μm and about 3.0 μm and preferably between about 1.0 μm and about 2.0 μm. In another embodiment, the nano-equivalent diameter of the crystals are between about 100 nm and about 400 nm and preferably between about 120 nm and about 300 nm and more preferably between about 150 nm and 250 nm. In another embodiment, the nano-crystal aspect ratio of the crystals is between about 2 and about 4. In still another embodiment, the nano-crystal domain size of the crystals is between about 170 Å and about 325 Å, preferably between about 220 Å and about 325 Å and more preferably between about 265 Å and about 290 Å.

Upon analysis of the shortening composition provided herein, the entropy of melting per mol of solid fat was used as an indicator of the structural order of the fat crystals. It is calculated by dividing the molar enthalpy of melting of the solid fraction by the melting temperature (in degrees Kelvin). A higher entropy of melting is indicative of a higher structural order in the crystal. In some embodiments, the shortening composition have an entropy of melting between about 250 J mol⁻¹K⁻¹ and about 350 J mol⁻¹K⁻¹ and preferably between about 290 J mol⁻¹K⁻¹ and about 340 J mol⁻¹K⁻¹. In some embodiment, the entropy of melting of the shortening composition is at least about 250 J mol⁻¹K⁻¹ or at least about 290 J mol⁻¹K⁻¹. In another embodiment the entropy of melting of the shortening composition is at the most about 340 J mol⁻¹K⁻¹ or about 350 J mol⁻¹K⁻¹.

One of the preferred embodiment of the invention comprises a non-interesterified mixture of 29.5% fully hydrogenated soybean oil (FHSO), 69.5% soybean oil (SO), and 1% GMP crystallized to beta polymorphic form under extremely high cooling rates under high shear. Without wishing to be bound to theory, Applicant herewith suggests that the GMP co-crystallizes with the FHSO, thus destabilizing the crystalline lattice, decreasing melting point and improving the plasticity of the fat crystal network.

As shown in the examples, alterations of the concentration of each component within the blend allows for alteration of specific properties of the final product. The properties can be tailored to fit a product useful for numerous food and food preparation applications understood by one skilled in the art, such as a spreadable food product.

The present invention will be more readily understood by referring to the following examples which are given to illustrate the invention rather than to limit its scope.

### Example 1

### Control Shortening Characterization

The Anhydrous Puff Pastry shortening (APPS, also referred as the high-trans control or the control shortening) employed as a control was provided by Bunge Oils (Bradley, II, USA). All chemicals and organic solvents were purchased from Fisher Scientific and Sigma-Aldrich (ON, Canada).

TABLE 2
Composition of the commercial anhydrous puff
pastry shortening provided by Bunge Oils.

| Determination | Results | Unit Scale | Method Used |
|---|---|---|---|
| Free fatty acids | 0.03 | % as Oleic | AOCS Ca 5a-40 |
| Color, Yellow | 3 | Lovibond | AOCS Cc 13b-45 |
| Color, Red | 0.3 | Lovibond | AOCS Cc 13b-45 |
| Peroxide Value | 0 | Me/Kg | AOCS Cd 8-53 |
| Mettler Drop Point | 123.3 | F. | AOCS Cc 18-80 |
| Iodine Value | 70 | Cg/g | AOCS Cd 1-25 |
| SFC @ 10° C. | 61.9 | % | AOCS Cd 16b-93 |
| SFC @ 21.1° C. | 42.5 | % | AOCS Cd 16b-93 |
| SFC @ 26.7° C. | 32.4 | % | AOCS Cd 16b-93 |
| SFC @ 33.3° C. | 22.5 | % | AOCS Cd 16b-93 |
| SFC @ 40° C. | 13.9 | % | AOCS Cd 16b-93 |

### Example 2

### Oil Migration Ratio (OMG)

Migration studies were performed according with the technique described previously by Dibildox-Alvarado et al. (E. Dibildox-Alvarado, J. Neves Rodrigues, L. A. Gioielli, J. F. Toro-Vazquez and A. G. Marangoni. Effects of Crystalline Microstructure on Oil Migration in a Semisolid Fat Matrix. Cryst. Growth Des., 2004, 4, 731-736). Table 3 shows the OMG (%) values for all the studied samples. Empty cells in the table correspond to blends that were discarded since they were extremely fluid or hard and hence did not meet the requirements of the study. Compared with most fats, the Bunge shortening, used as a control, had a relative low value of oil migration (2.8); which is indicative of a high oil binding capacity. Fat mixtures with 40% hardstock revealed a smaller amount of oil migrated, nevertheless, compositions comprising 40% hardstock seemed excessively rigid. Only a few formulation/votator configuration combinations presented an OMG value comparable with the Bunge shortening (underlined in Table 3). In particular, blends with a FHSO:SO proportion of 30:70 before the addition of any emulsifier (with configurations AB and ABC); and after the incorporation of GMS or GMP (with configurations ABC and ACB) showed an adequate oil binding capacity.

TABLE 3
Oil Migration data (% w/w total weight lost) of blends
with different FHSO:SO proportions and configurations
in the votator line (Standard Error (%) <10%).

FHSO:SO PROPORTION

| | | | | |
|---|---|---|---|---|
| EMULSIFIER - VOTATOR | 10:90 | 20:80 | 30:70 | 40:60 |
| CONFIGURATION | | | | |
| NO EMULSIFIER AB | | 8.6 | 2.0 | 0.6 |
| NO EMULSIFIER ABC | | 6.8 | 2.4 | 1.4 |
| NO EMULSIFIER ACB | 27.8 | 19.7 | 5.9 | |
| 1% GMS AB | 36.9 | 7.7 | 1.8 | |
| 1% GMS ABC | 32.7 | 8.6 | 2.9 | |
| 1% GMS ACB | 35.6 | 7.6 | 2.6 | |
| 3% GMS AB | | 7.4 | | |
| 3% GMS ABC | 31.0 | 5.0 | | |
| 3% GMS ACB | 34.0 | 15.4 | | |
| 1% SSL AB | 30.6 | | | |
| 1% SSL ABC | 34.6 | 21.1 | 9.4 | |
| 1% SSL ACB | 30.7 | 18.3 | 10.2 | |
| 3% SSL AB | 45.4 | | | |
| 3% SSL ABC | 30.5 | 19.8 | 9.8 | |
| 3% SSL ACB | 41.7 | 33.5 | 11.8 | |
| 1% SMS ABC | | 19.5 | 11.3 | |
| 1% SMS ACB | | 14.2 | | |
| 3% SMS ABC | | 38.5 | 7.8 | |
| 3% SMS ACB | | 17.7 | | |
| 1% PGMS ABC | | 17.0 | 6.6 | |
| 1% PGMS ACB | | 12.5 | 6.1 | |
| 3% PGMS ABC | | 22.6 | 13.1 | |
| 3% PGMS ACB | | 19.1 | 13.3 | |
| 1% P-choline ABC | | | 7.9 | |
| 1% P-choline ACB | | | 7.1 | |
| 3% P-choline ABC | | | 11.6 | |
| 3% P-choline ACB | | | 12.1 | |
| 1% BFP ABC | | | 5.8 | |
| 1% BFP ACB | | | 6.9 | |
| 3% BFP ABC | | | 11.6 | |
| 3% BFP ACB | | | 10.4 | |
| 1% SMP ABC | | | 15.2 | |
| 1% SMP ACB | | | 5.6 | |
| 3% SMP ABC | | | 15.7 | |
| 3% SMP ACB | | | 7.8 | |
| 1% GMP ABC | | | 3.1 | |
| 1% GMP ACB | | | 3.8 | |
| 3% GMP ABC | | | 28.3 | |
| 3% GMP ACB | | | 7.3 | |

### Example 3

### Solid Fat Content (SFC)

Glass NMR tubes (10 mm diameter) were filled with approximately 3 g of sample, immersed and kept for 30 minutes in water baths set at the different temperatures ranging from 10 to 80° C. Solid fat content measurements were taken by pulsed Nuclear Magnetic Resonance (pNMR) with a Bruker PC/20 series NMR analyzer (Bruker, Milton, ON, Canada). Eight determinations on each of three replicates per sample were performed.

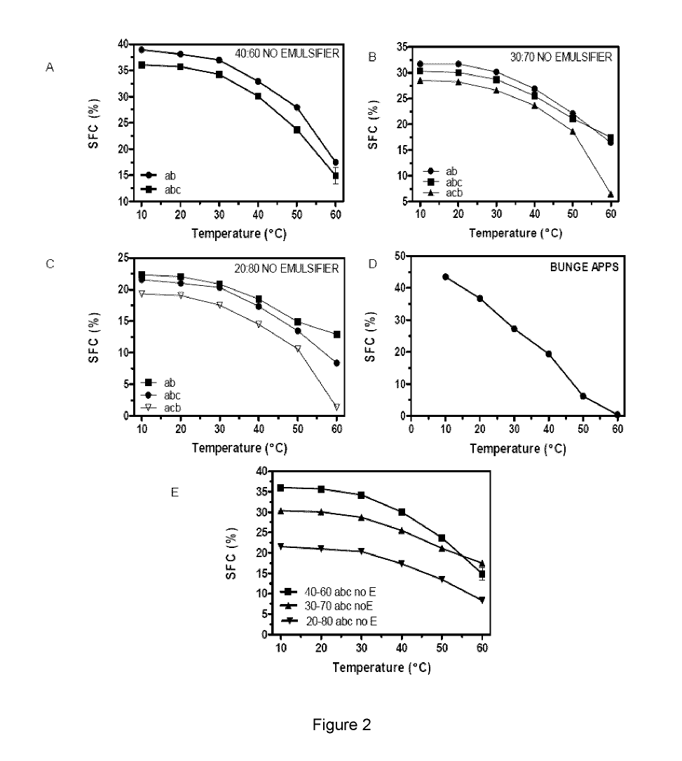

SFC curves as a function of temperature for the sample control (Bunge shortening) and blends crystallized in the votators line before the addition of emulsifier are shown in FIG. 2. The evolution of SFC with temperature was not only dependent on the proportion of solid fat in the blends, but also on the configuration of the votators' units. SFC profiles of fat mixtures comprising 10% (data not shown), 20%, 30% and 40% of hardstock are significantly different with each other (P<0.05). Furthermore, blends crystallized with AB configurations showed the highest values of SFC in the whole range of temperatures analyzed. On the other hand, ACB blends displayed SFC values significantly smaller (P<0.05) than those observed in ABC samples.

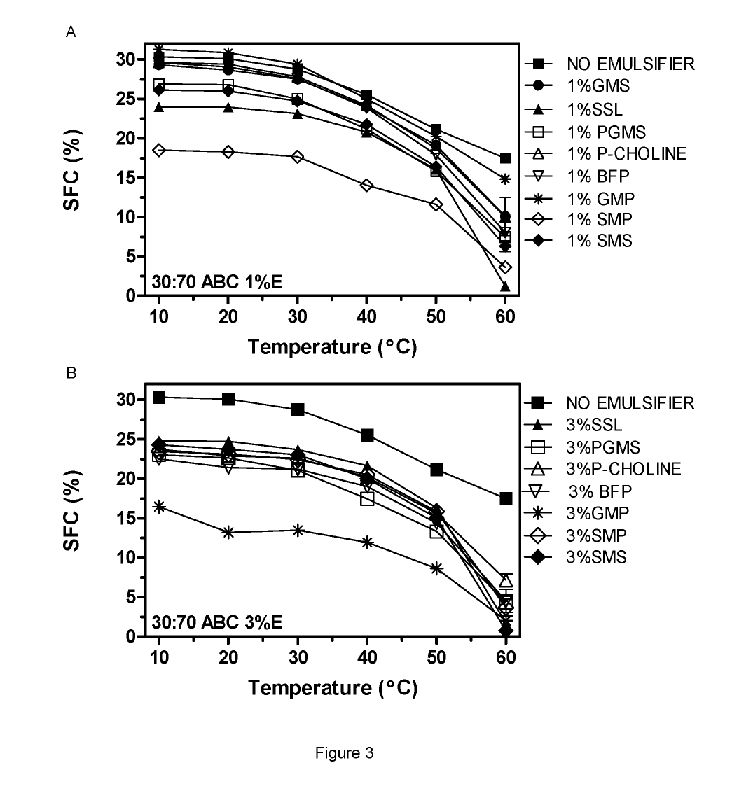

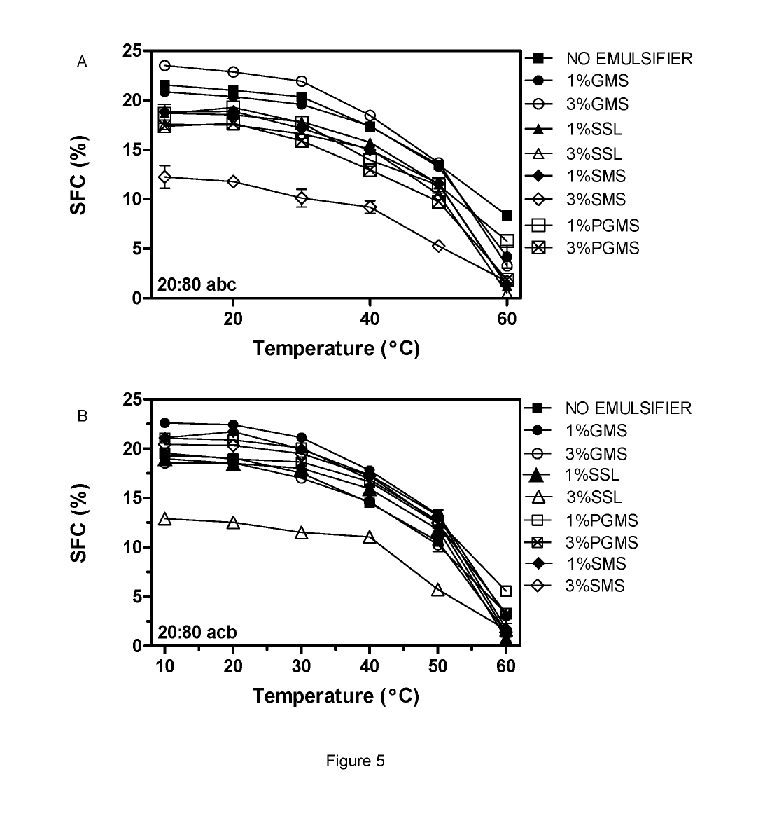

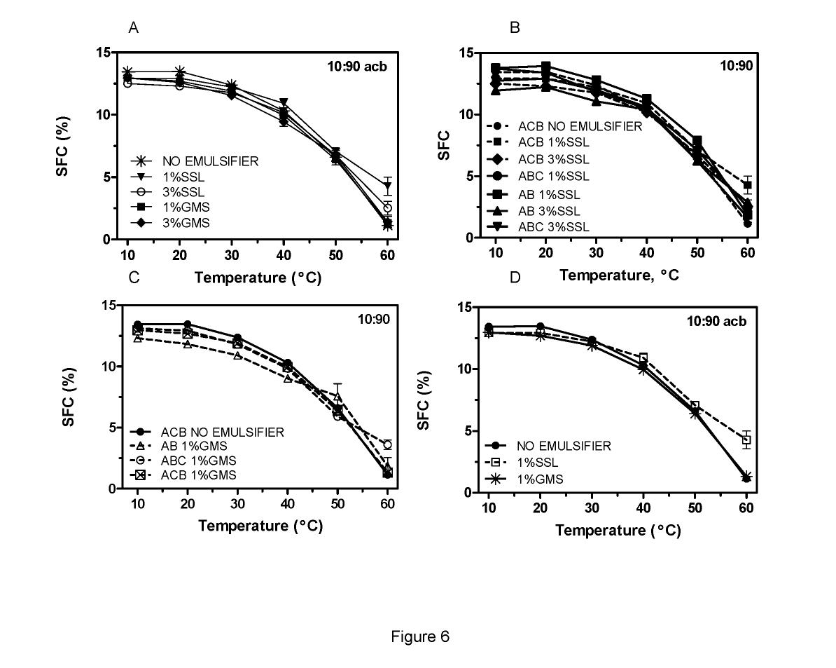

FIGS. 3, 4, 5 and 6 show the SFC profiles for various fat blends before and after the incorporation to the formulation of 1 or 3% of emulsifier. The results show that it was not possible to obtain a SFC profile similar to the one obtained for the shortening control by changes in the formulation or crystallization conditions of the hardstock:oil mixtures. In general, the curves displayed at low temperatures a plateau followed by a sharp reduction in the SFC values with an increase in temperature. In contrast, the control sample presented an inverse linear relationship between SFC and temperature.

The different emulsifiers added either at 1 or 3% exerted a different effect on different mixtures, and this effect changed with the saturation of the system. Thus, for example in the 30:70 ABC fat blend, SMP addition caused the largest drop in SFC at a concentration of 1%. However, at a 3% level, GMP was the surfactant that caused the highest decreased in the solid fat content of the blend. It is worth mentioning that different results were obtained with different votator configurations. Hence, SSL and PGMS had the most significant depressing effect in blends with 30% of hardstock and crystallized with a votator set up in an ACB configuration.

Another important observation that arose from these results lies in the fact that the alterations in SFC induced by changes in formulation or votator configurations are more pronounced at higher temperatures.

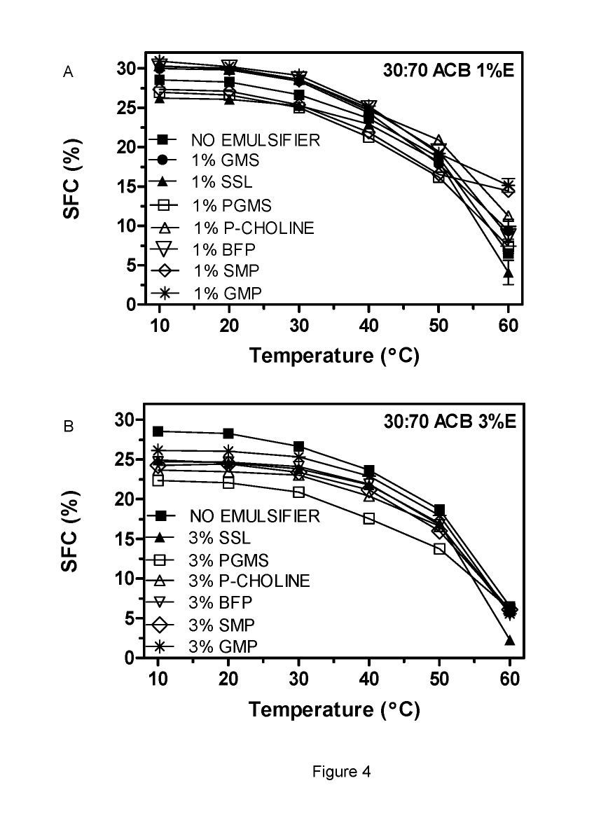

Fat blends comprising 30% hardstock (FIGS. 3 and 4) seem to have a SFC-T profile closer to the one observed in the shortening control (FIG. 2D), even though they show important changes in the SFC values at temperatures higher than 30° C.; in contrast with the slight and continuous change in SFC along the temperature scale observed in the sample control.

### Example 4

### Melting Profile

A differential scanning calorimeter (DSC; Q1000, TA Instruments, New Castle, Del., USA) was used in the thermal analysis of the fat blends and the control. The instrument heat capacity response was calibrated with sapphire, and the heat flow was calibrated with indium. Approximately 10 mg of the fat sample was placed in alodined pans and sealed hermetically (an empty pan served as reference). All measurements were performed at a heating rate of 5° C./min. Thermograms were evaluated using TA Instruments Universal Analysis Software. The peak melting temperature (Tₘ) and the enthalpy of melting (ΔHₘ) were determined. The average and standard deviation of four replicates are reported in this study.

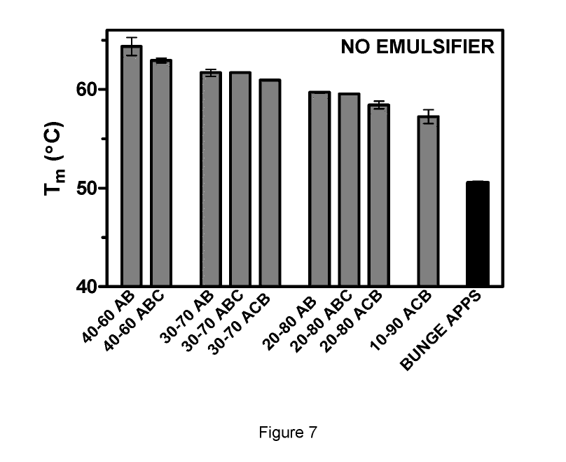

The results showed a melting temperature (Tₘ) of 50.52±0.20° C. and a melting enthalpy (ΔHₘ) of 44.95±0.60 J/g for the control (Bunge APPS). FIGS. 7, 8, 9, and 10 show the Tₘ values obtained for the fat blends. Also, the corresponding enthalpies of melting are presented in FIGS. 11, 12, 13 and 14.

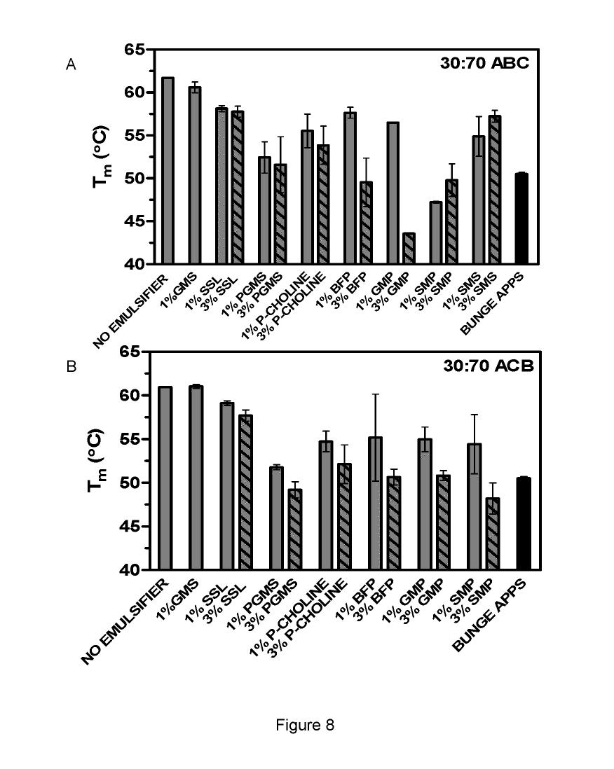

The results show that, in general, all fat blends without emulsifiers crystallized in the votator line had melting temperatures higher that the observed in the sample control (FIG. 7). In the case of fat blends comprising 30% hardstock and crystallized with an ABC configuration the incorporation of 1% of PGMS and 3% of BFP or SMP led the Tₘ similar to the one observed in the sample control (FIG. 8). An important decrease in Tₘ to values similar to the sample control was observed after the addition of PGMS, P-CHOLINE, BFP, GMP and SMP in 30:70 hardstock:oil ACB fat samples (FIG. 8).

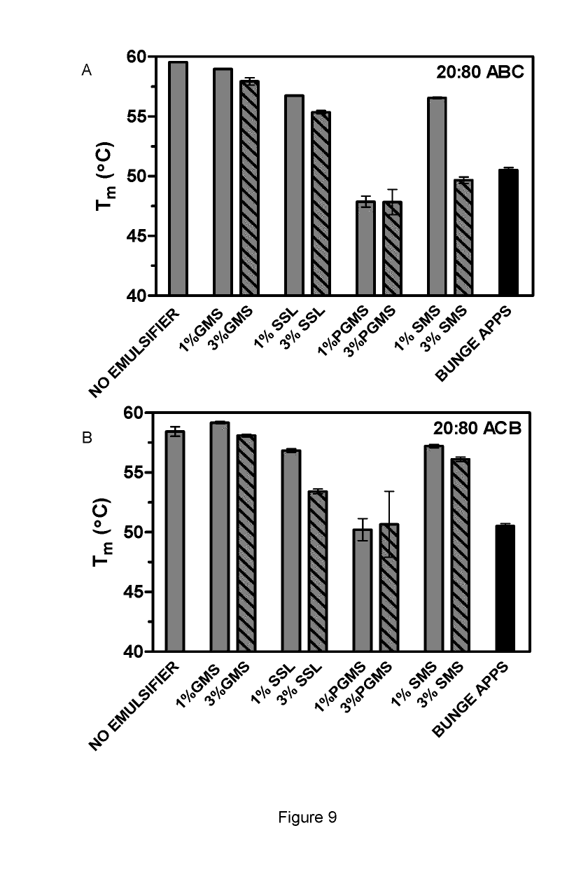

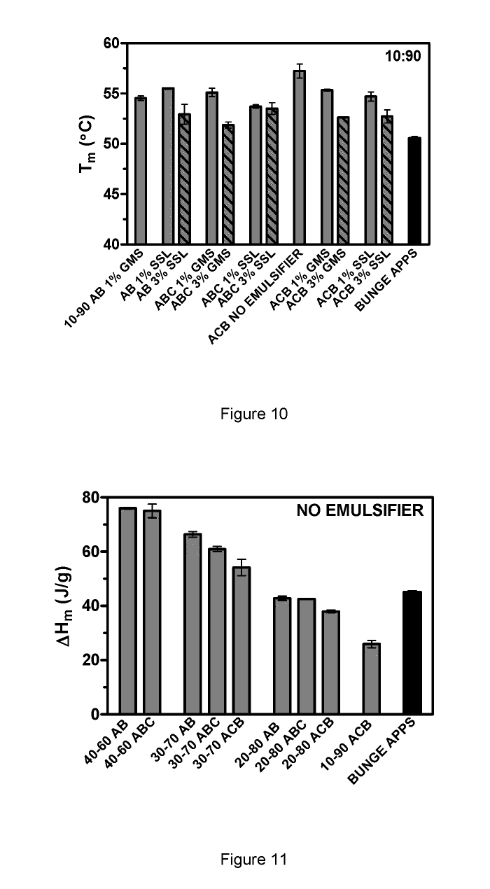

Fat blends with 20% of hardstock also showed higher melting temperatures than that observed for the control. Only the incorporation of PGMS and 3% of SSL induced a decrease in Tm until values comparable to the control (FIG. 9). Blends with only 10% FHSO with and without emulsifier presented similar melting points to the fat control (FIG. 10).

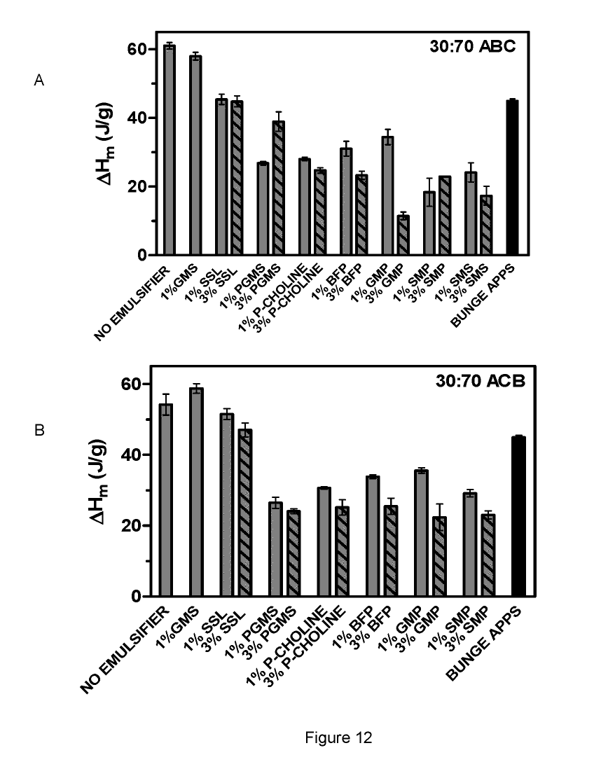

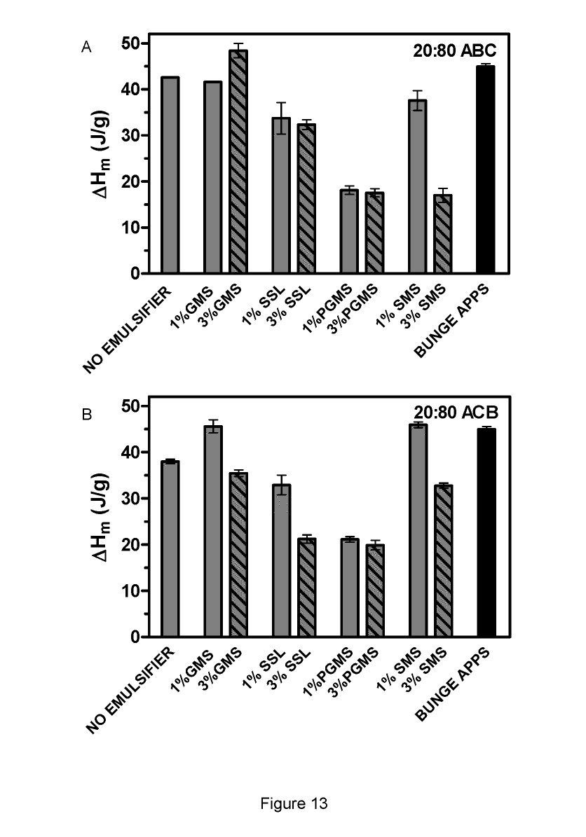

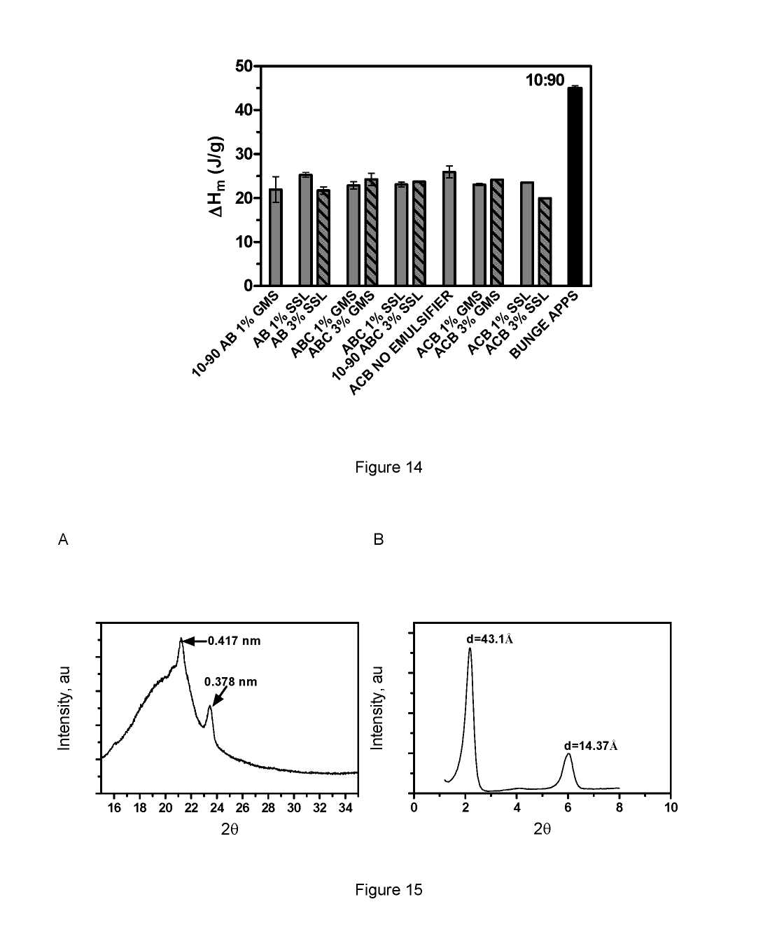

As expected, the melting enthalpies (ΔHₘ) of fat blends with 40% and 30% of hardstock were significantly higher (P<0.005) than the value observed in the commercial shortening (FIGS. 11 and 12). Samples comprising 20% hardstock had similar enthalpies to the control (FIG. 13) meanwhile those ΔHₘ obtained in blends comprising 10% hardstock were significantly lower (FIG. 14).

It is worth noting that formulations with emulsifier led to significant decreases in the melting enthalpies of blends comprising 30% hardstock, independent of the votator configuration used.

### Example 5

### Crystal Characterization

Fat blends were evenly distributed in the hollow of the glass X-ray slide and the XRD experiments were performed using a Rigaku Multiflex Powder X-ray diffractometer (Rigakug, Japan. The copper lamp (λ=1.54 Å for copper) was set to 40 kV and 44 mA. A 0.57 divergence slit, 0.57 scatter slit and 0.3 mm receiving slit were used. For the small angle X-ray diffraction analysis (SAXD) five replicates were scanned from 0.9 to 8 degrees at 0.02°/min. The wide angle X-ray diffraction analysis (WAXD) was carried out scanning the samples from 16 to 35 degrees at 0.5°/min. PeakFit™ software (Seasolve, USA) was used to analyze the obtained patterns in both, SAXD and WAXD data.

From the SAXD patterns, the crystalline domain size (ξ) can be estimated from the width of a diffraction peak, usually the first small angle reflection corresponding to the (001) plane. ξ was calculated by Scherrer formula:

ξ=(Kλ)/FWHM cos(θ)

where K is the shape factor, θ is the diffraction angle, FWHM is the full width at half maximum the intensity in radians and λ is the wavelength of the X-ray. The dimensionless shape factor provides information about the “roundness” of the particle. For a spherical particle the shape factor is 1, for all other particles it is smaller than 1. 0.9 is the typical value used for crystallite of unknown shape and the magnitude employed in this study. The Scherrer equation is limited to nano-scale particles and it is not applicable to sizes larger than about 100 nm.

The patterns obtained for the sample control (represented as a black bar to the far right of each graph) illustrate the prevalence of the β′ polymorphic form with short spacing values corresponding to the orthorhombic subcell as it can be observed in FIG. 15. These results are in agreement with those reported by the manufacturer of the shortening control. In the case of the Domain size (ξ) calculated by applying the Scherrer analysis to the reflection peak corresponding to the (001) plane the results show a value of 247.9±46.8 Å.

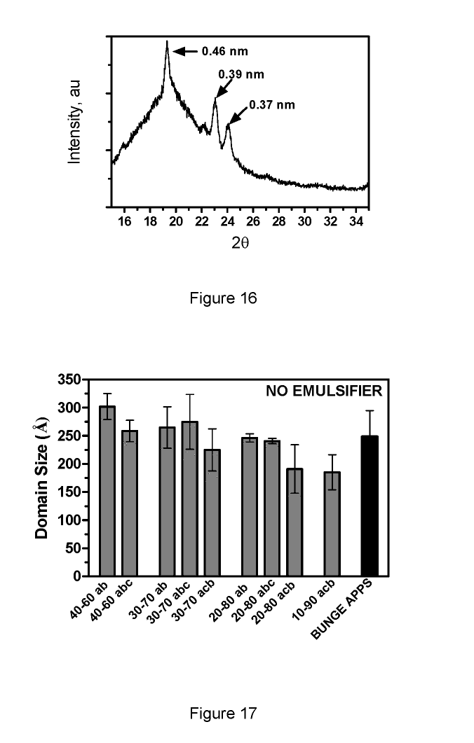

In the case of all the samples crystallized using an in line-votator processing, the data obtained by X-ray diffraction in the wide angle region reveal a β polymorphic form independent of the votator set up and the formulation of the fat blend (FIG. 16).

### Example 6

### Domain Size

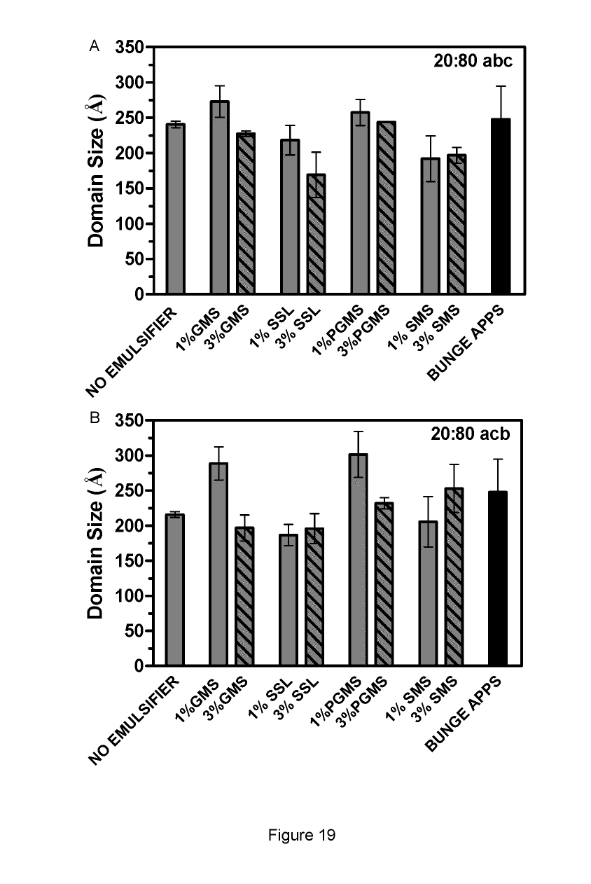

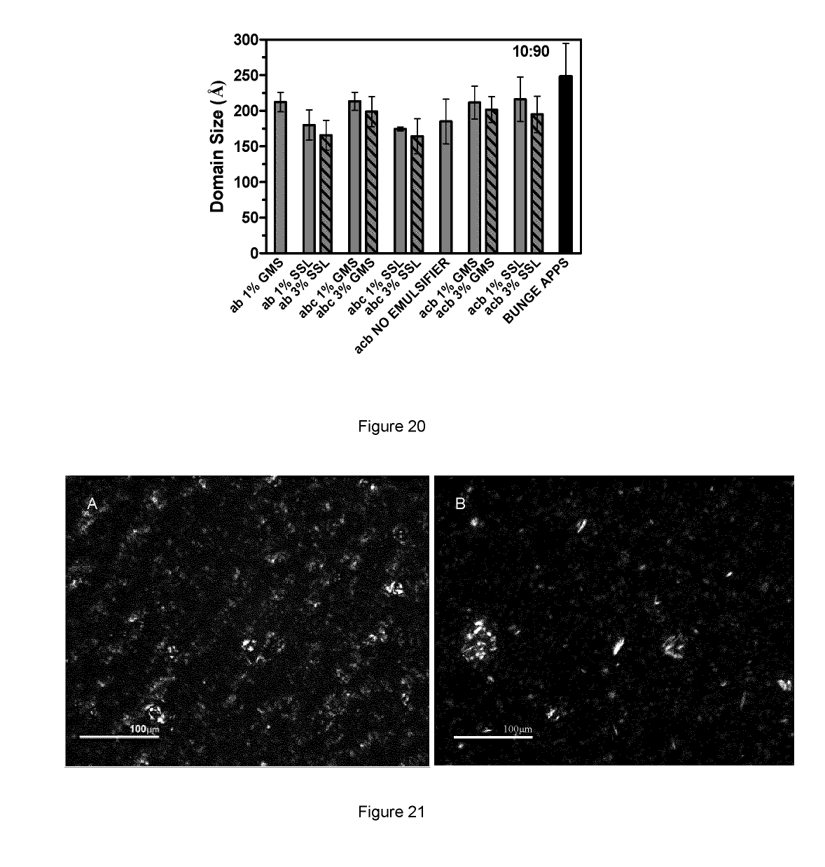

FIGS. 17, 18, 19 and 20 show the domain size values for the sample control and various formulations of fat mixtures obtained by crystallization using various votator's configuration. Collectively, the results show that there are not significant differences (P<0.005) between blends with different proportions of hardstock or the type of configuration for crystallisation a (FIG. 17). In addition, domain sizes in non-trans fat blends were not significant different to the value in the commercial shortening. Only mixtures comprising 10% of hardstock presented significantly reduced domain sizes (P<0.005) compared with the value acquired for the sample control (FIG. 20).

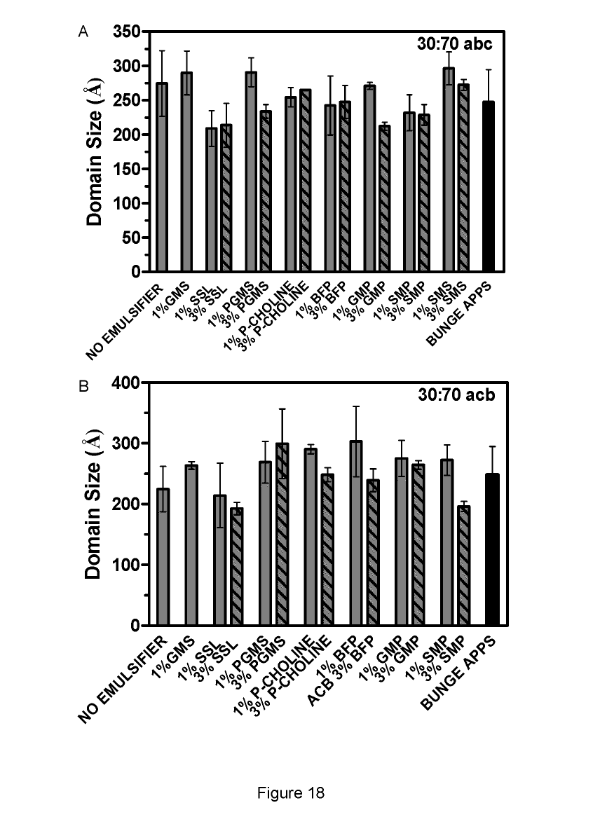

In the case of blends comprising 30:70 hardstock:oil (FIG. 18), it can be observed that only 1% of SSL significantly reduced (P<0.005) the domain size of the blends. This effect did not change with a further increase in concentration of SSL until 3%. With respect to samples comprising 20:80 proportions of hardstock and oil, respectively, SSL and SMS induced a noticeable decrease in the domain size of samples prepared using the ABC configuration which was more evident at a concentration of 3%; however there were no significant differences (P<0.005) before and after the addition of emulsifier when the configuration used in the votator was ACB.

### Example 7

### Microstructure/Microcrystalline Structure

Polarized light microscopy (PLM) was used to observe the microstructure in all samples. A small quantity of the crystallized fat was placed on the slide and a cover slip was then gently laid over the fat to remove air and spread the fat. The slide was then transferred into a thermostatically controlled microscope stage at 20° C. (Model LTS 350, Linkam Scientific Instruments, Surrey, UK). Samples were imaged using a Leica DM RXA2 microscope with polarized light (Leica Microsystems, Richmond Hill, Canada) and equipped with a CCD camera (Q Imaging™ Retiga 1300, Burnaby, BC, Canada). All images were acquired using a 40× objective lens (Leica, Germany). The camera was set for autoexposure. Openlab™ 5.5.0 software (Improvision, Waltham, Mass., USA) was used to acquire images. Focused images were stored as uncompressed 8-bit (256 greys) greyscale TIFF files with a 1280×1.024 spatial resolution. At least 5 images were captured from each of the five replicates prepared.

Microstructural analysis was carried out by image analysis employing the Adobe Photoshop CS5™ software (Adobe Systems Inc., San Jose, Calif., USA) and filters from the Fovea Pro™ 4.0 software (Reindeer Graphics, Inc., Asheville, N.C., USA). In order to discriminate between features and background and to measure the features sizes a manual threshold was applied to all the pictures to convert the greyscale images to binary images. The microstructural elements were determined using the filter tools included in the Fovea Pro software.

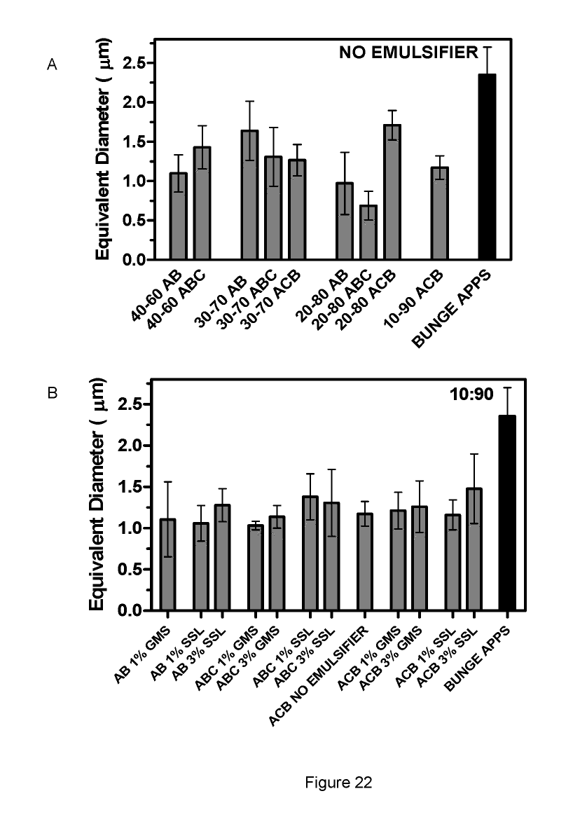

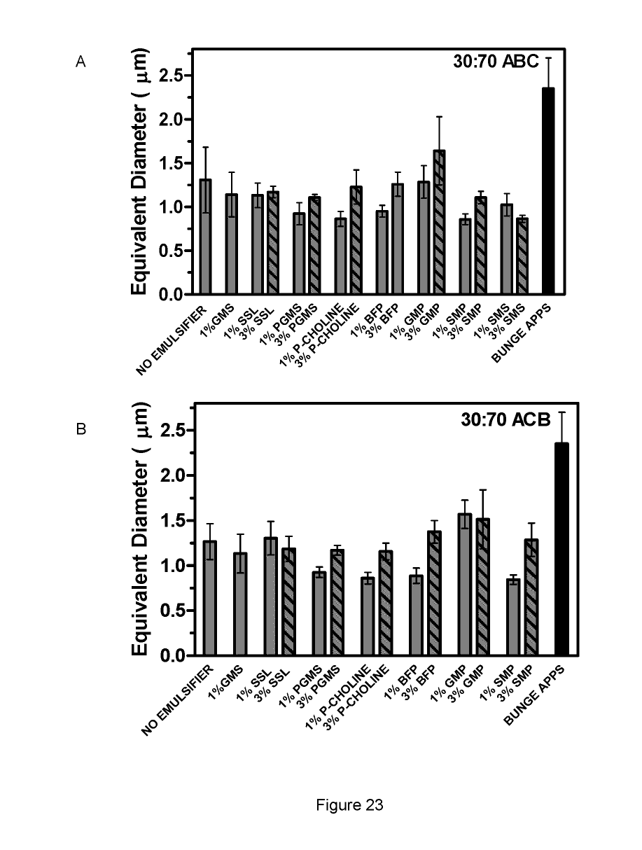

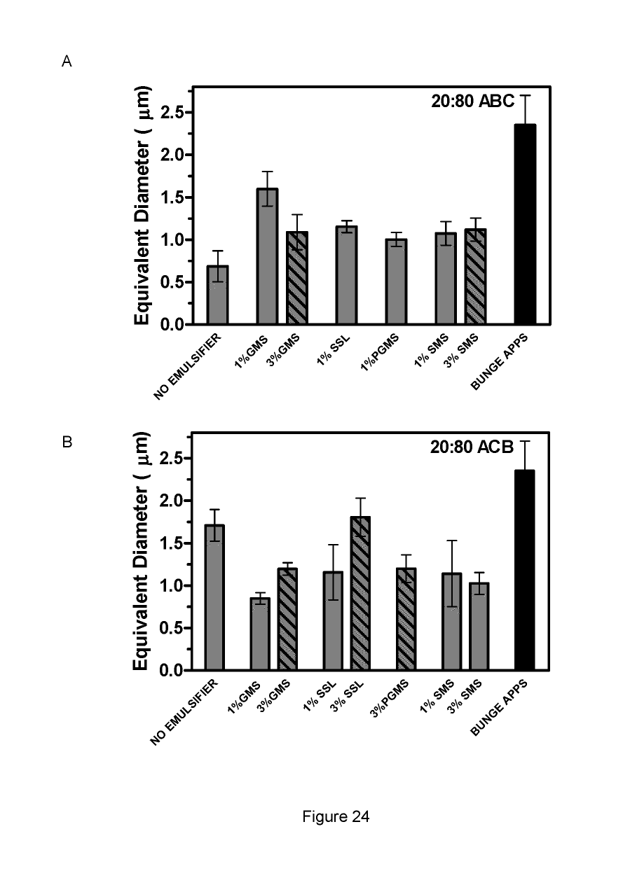

The visual observation of the images obtained by PLM corresponding to the sample control (Bunge APPS) allowed the identification of spherical microstructural elements and a granular texture which indicate the spherical nature of fat mesocrystal aggregates (FIG. 21A). The feature analysis in the mesoscale range revealed a particle average size of 2.35±0.51 μm. A similar microstructure was identified in all the PLM images of the mixtures obtained with the votator line. FIG. 21B shows representative examples of the micrographs acquired. It is worth noting that the microscopic observations were performed after the complete crystallization of the samples in order to observe the obtained mesostructure under the votator line conditions. FIGS. 22, 23 and 24 show the equivalent diameter of the minimum microcrystalline structures obtained from the image analysis of the PLM micrographs. The results show that, in general, all the samples crystallized on the votator line had significantly smaller microstructural elements (P<0.005) compared to those observed in the sample control; this behaviour is independent of the hardstock ratio and the votator set up. Another interesting observation is that, in particular, the addition of GMP to the blend comprising 30% hardstock produced a significant increase of the microstructural elements.

### Example 8

### Nanoplatelets

In order to discard oil fraction and favour single crystals observation, each sample was treated at 10° C. as follows. The fat blend was suspended in isobutanol approximately in the ratio 1:50 using a glass stirring rod to obtain a uniform suspension. The fat+isobutanol mixture was homogenized to 30,000 rpm with the shear homogenizer (Power Gen 125, Fisher Scientific) for 10 min. Then, the crystals were separated by vacuum filtration through a glass fibre filter of 1.0 μm pore size. After filtration, the recovered solid was re-suspended in isobutanol and re-homogenized for 10 min in order to obtain a suitable dispersion of crystals. Finally the mixtures were sonicated for 60 min using an ultrasonic processor (Bransonic 1210R-DTH, Branson Ultrasonic Corporation, Danburry, Conn., USA) to complete the dispersion of the fat crystals.

Five microliters of dispersion were placed on a copper grid with perforated carbon film (Canemco-Marivac, Quebec, Canada), and excess liquid was blotted automatically for 2 s using filter paper. A staining aqueous solution of 2% of uranyl acetate was used to enhance contrast. Subsequently, the sample was transferred to a cryo holder (Gatan Inc., Pleasanton, Calif., USA) for direct observation at −176° C. in a FEI Tecnai G2 F20 energy-filtered cryo-TEM operated at 200 kV in low dose mode. Energy filtering improves image contrast by eliminating inelastically scattered electrons, which causes a blurring effect on micrographs. Zero-loss energy-filtered images were taken using a Gatan 4k CCD camera. Micrographs were stored and analyzed using DigitalMicrograph™ software (USA).

Image J 1.42q software (USA) was employed for a semiautomatic analysis procedure. Data were processed using GraphPad Prism 5 software (GraphPad Software, Inc., San Diego, Calif., USA).

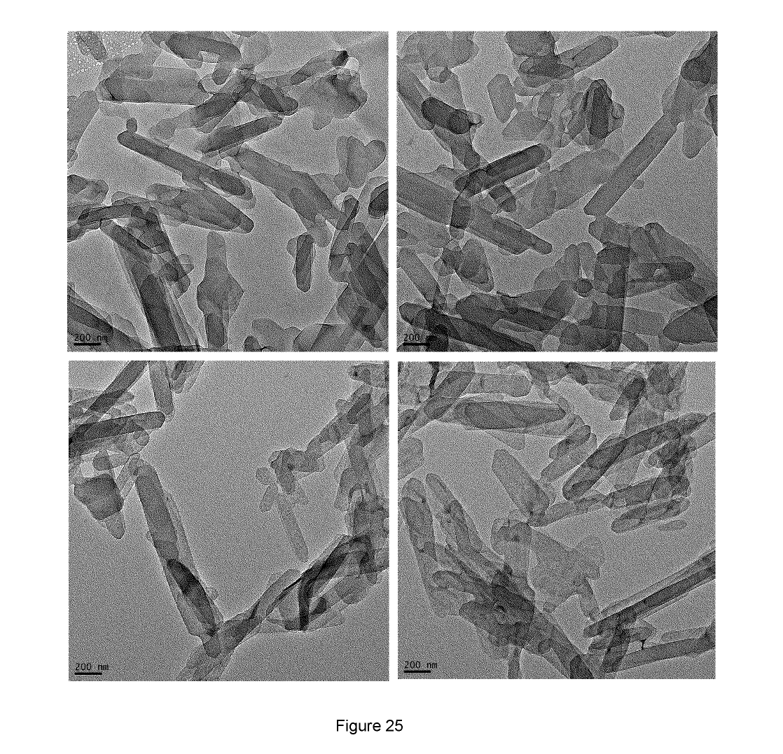

FIG. 25 shows representative pictures of the Cryo-TEM images obtained for the control sample. In these images, it is possible to observe that the primary crystal of the puff pastry shortening is a platelet. These nanoplatelets are clearly distinguished from each other which allowed the determination of their dimensions by image analysis. From the measurement of the platelet dimensions, the frequency distributions for the nanocrystal length and width were obtained and arithmetical median values calculated. The results of the nanostructural studies revealed that the dimensions of the nanoplatelets present in the control sample are 434 and 110 nm for length and width respectively. In addition, the results obtained by the Scherrer analysis show a thickness value of 24.8 nm.

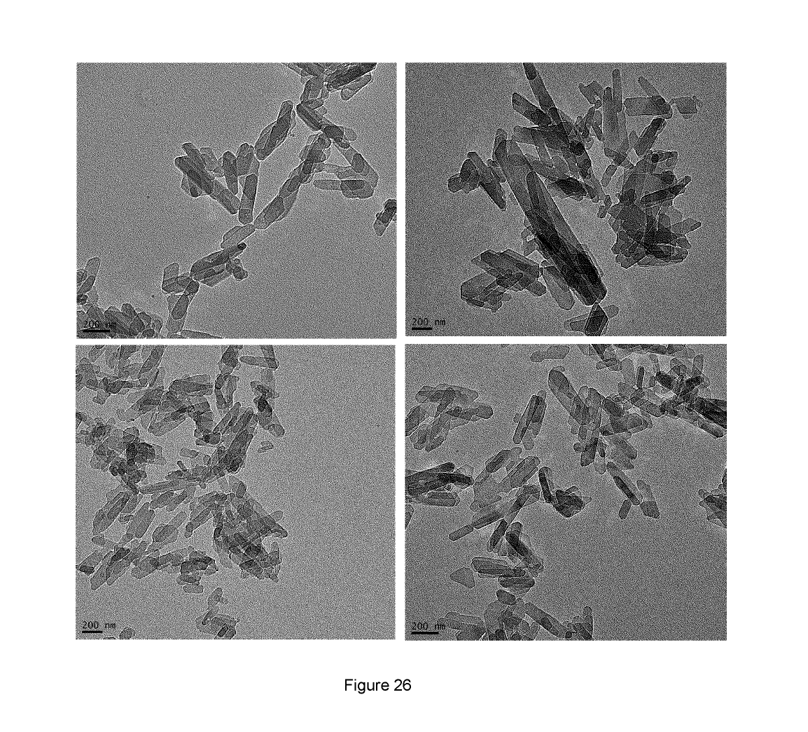

FIG. 26 shows representative pictures of the Cryo-TEM micrographs obtained for the fat blends crystallized in the scraped surface heat exchanger. In the images, it is possible to observe that nanoplatelets dimensions were considerably smaller than those observed in the sample control. Additionally, the fat mixtures presented a visible lower platelet aspect ratio.

### Example 9

### Nanoequivalent Diameters

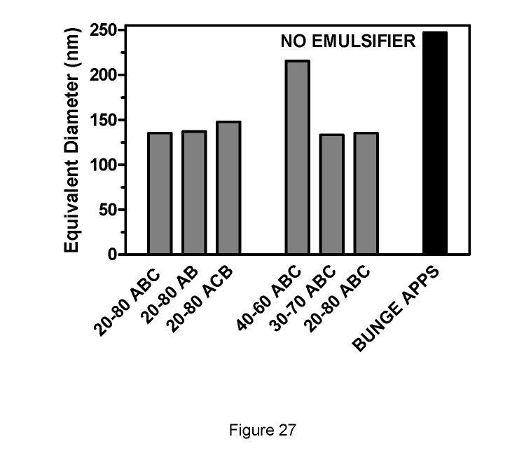

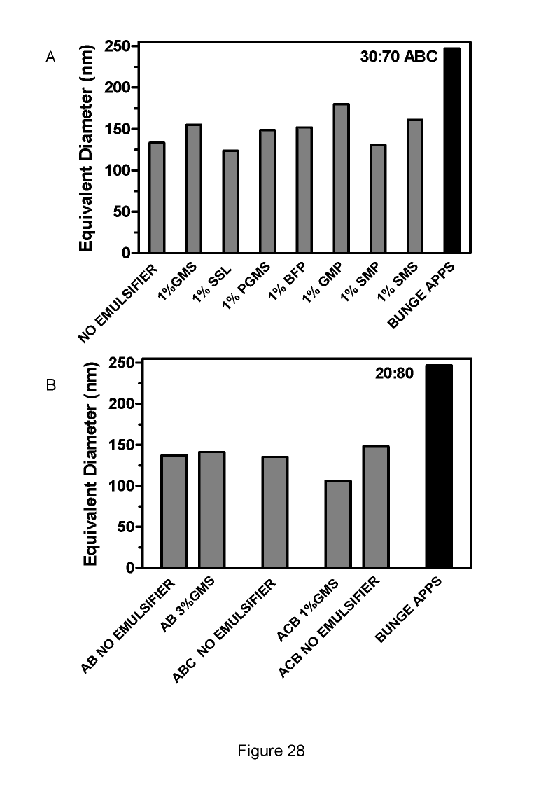

In order to easier compare the nanostructure of the shortening control with the various fat mixtures, the nano-equivalent diameters (assuming the presence of spherical nanostructural elements) was calculated and the results are shown in FIGS. 27 and 28. The analysis yielded nano-equivalent diameters significantly smaller (P<0.005) in the various fat mixtures than in the sample control. Changes in the equipment configurations and sample saturation (10-30 hardstock) did not affect the nanoplatelet equivalent diameters. Fat blends comprising 40% hardstock presented nano-equivalent diameters considerably higher than the rest of the fat blends, however they did not reach the size of the shortening control (FIG. 27).

The addition of SSL and SMP at a concentration of 1% in 30:70 hardstock:oil mixtures led to a decrease in the nano-equivalent diameters compared to the blend with no emulsifier. On the other hand GMS, PGMS, BFP, GMP and SMS at a concentration of 1% induced an increase in nanoplatelet size and GMP caused the greatest increase in equivalent diameter.

The aspect ratio of the commercial shortening and the fat mixtures were calculated and the results obtained confirmed the visual examination of the cryo-tem images (FIGS. 25 and 26). The nanoplatelet aspect ratio in the sample control is 4, in contrast with values between 2.5 and 3.5 for samples crystallized in the scraped surface heat exchanger.

### Example 10

### Mechanical/Rheological Properties

Samples were placed into the wells of polyvinylchloride (PVC) molds (discs of 3.2 mm thick and 20 mm in diameter) and then stored at 4° C. until the moment of analysis. Rheological measurements at small deformations were performed using an AR2000 rheometer (TA Instruments, Mississauga, ON, Canada) with a 2-cm flat plate attachment. The sample platform temperature was controlled, allowing for sample temperature to be maintained at 20° C. during analysis. Evaluation of the linear viscoelastic range (LVR) was determined using oscillatory stress sweeps from 1 to 1000 Pa at a constant frequency of 1 Hz. Storage moduli (G′) were determined within the LVR of the samples. To prevent slippage, sandpaper (grade 60) was attached to the lower surface of the geometry and the upper surface of the Peltier base of the rheometer.

In order to predict the product's processing and/or end-use performance the yield stress values (θ*) were determined from the rheological data as the stress (in Pa) required to produce a decrease in G′ of 10% of the LVR region.

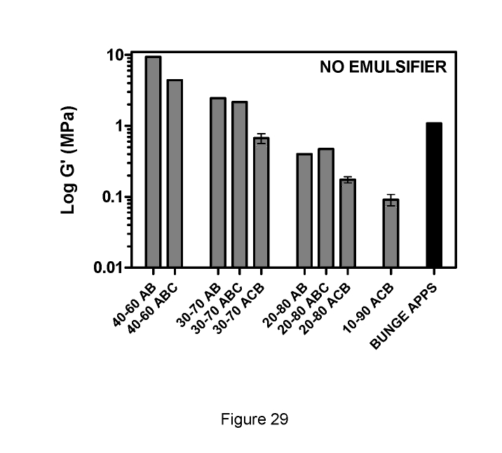

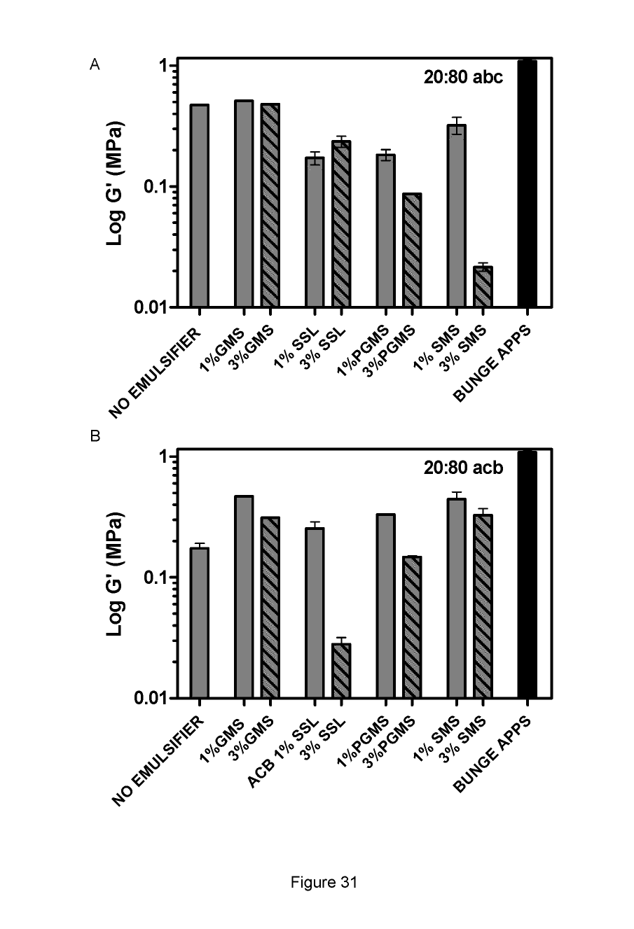

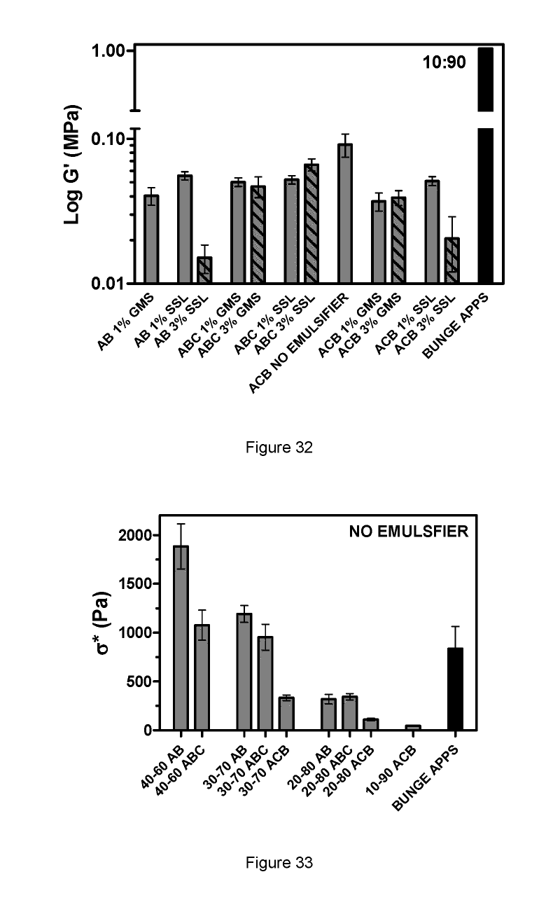

Changes in the solid-like behaviour of all samples represented by the storage moduli G′ are shown in FIGS. 29, 30, 31 and 32. In general, independent of the hardstock:oil proportion, AB configurations led to the highest G′ values followed by the ABC and finally ACB unit configurations (FIG. 29). As expected, fat mixtures with higher amounts of hardstock had higher G′ values and in particular 30:70 blends with an ABC configuration had a G′ that most closely matched the G′ of the Bunge shortening control.

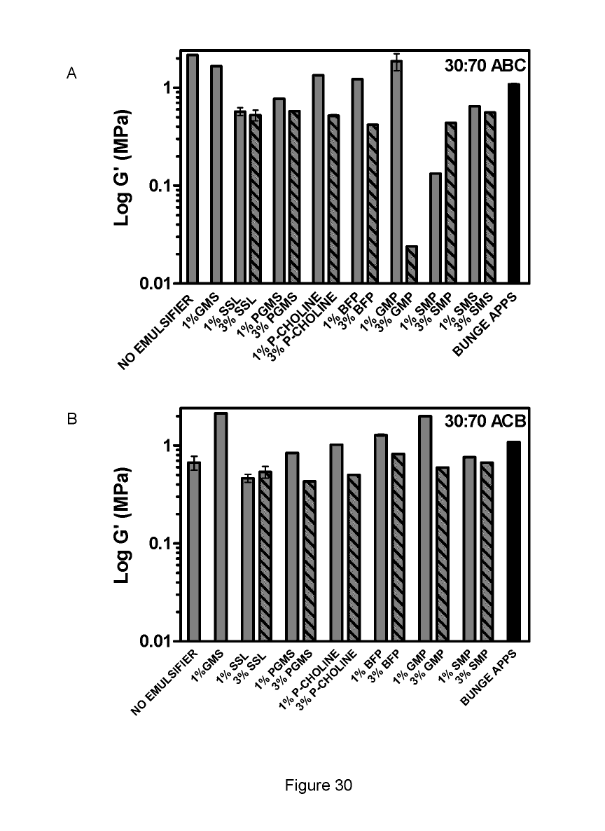

The addition of surfactants significantly affected the mechanical properties of the 30:70 hardstock:oil fat blends (FIG. 30). In an ABC configuration, it is possible to observe that the incorporation of emulsifiers reduced the G′ values. GMS, P-choline, BFP® and GMP decreased G′ toward values slightly higher but comparable the Bunge shortening; meanwhile SSL, PGMS, SMS and SMP led to a G′ reduction below the control value. Further increases in the levels of emulsifiers resulted in a noticeable decrease in the storage moduli, well below the desirable control value. For the ACB configuration, it is shown that different emulsifiers had different effects on the value of G′ depending the type and concentration of surfactant used. In this case it is noted that again GMS, P-choline, BFP and GMP led to G′ values similar to the obtained in the shortening control.

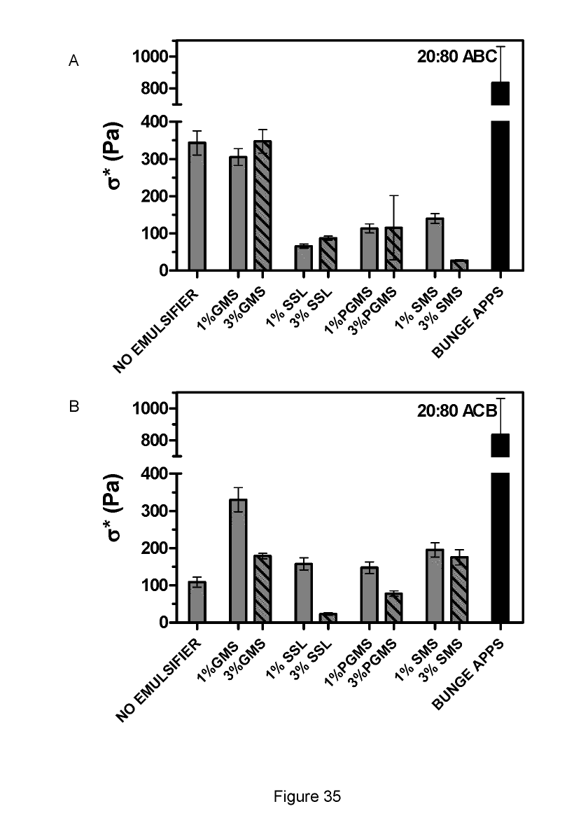

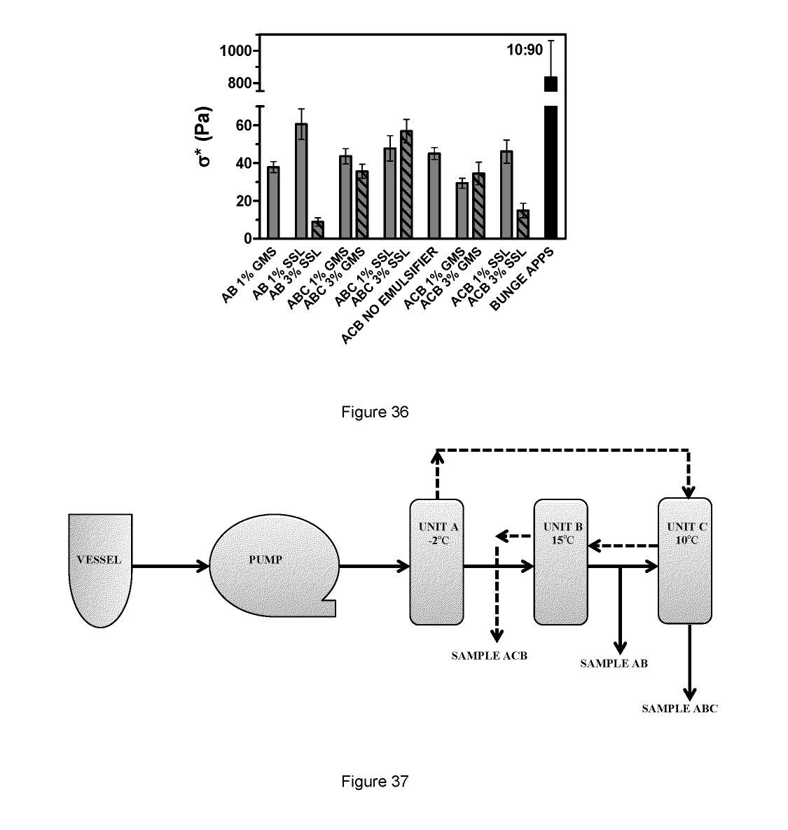

The yield stress (σ*) is one of the most important macroscopic properties of fats and fat-containing products because it is strongly correlated to sensory perception of hardness and spreadability, as well as to material stability. The apparent yield stress of a plastic solid is usually defined as the point at which, when the stress is increased, the deforming solid first begins to show liquid-like behaviour. In this work, it was considered that the stress at the limit of linearity (after a change in G′ of 10%) is the yield stress. FIGS. 33 to 36 show the results of the yield stress measurements for all the fat blends. As expected, yield stress of all fat blends decreased with a decreasing amount of the solid fat in the fat blends and with units set up going from AB to ABC and ACB. Interestingly, 30:70 and 40:60 hardstock:oil blends with ABC votator configurations showed a similar yield stress as the control (FIG. 33).

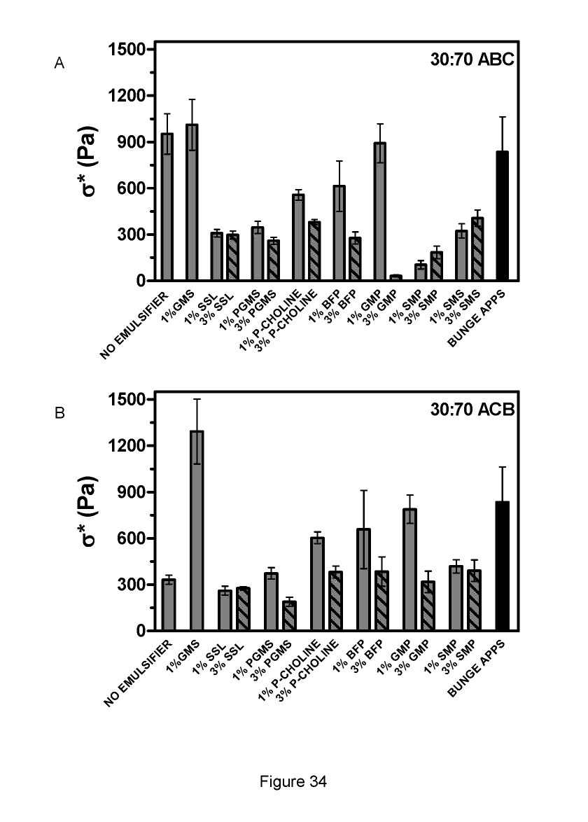

The incorporation of emulsifiers in the 30:70 ABC formulations (FIG. 34) revealed that only 1% of GMS and GMP generated yield stress magnitudes comparable to the commercial shortening. However, a further increase to concentrations of 3% had a negative effect since they reduced the yield stress significantly compared to the Bunge shortening. The effect of the addition of the other emulsifiers led to a large decrease in the yield stress resulting in values well below of the shortening control. In the case of 30:70 samples crystallized with an ACB votator set up, only BFP® and GMP in concentrations of 1% induced an increase in the yield stress until levels similar to the sample control.

It is worth noting that fat blends comprising 20% hardstock had yield stress values approximately 2 to 16 times lower than the control, meanwhile in mixtures comprising 10% hardstock the σ* values were between 14 and 80 times lower than the σ* value of the shortening control.

Table 4 shows an overview of the compositions with the most similar properties to the control shortening. The rheological properties in this group of fat mixtures are very similar to the control; however, blends with P-CHOLINE and BFP® released oil at a high rate relative to the commercial shortening.

Comparing the results acquired for the rest of the blends to those of the sample control, it is possible to note that the formulation with 30% fully hydrogenated soy (FHSO) in soybean oil (SO), with 1% glycerol monopalmitate and crystallized using an ABC unit votator configuration had properties that most closely matched the Bunge control sample.

TABLE 4
Physico-chemical properties of various fat blend formulations/votator configurations.

| | Physical | | | | | | | | | |
|---|---|---|---|---|---|---|---|---|---|---|
| | Properties | | Rheological | | Thermal | | Micro- | | Nanostructure | |
| | | SFC | Properties | | Properties | | structure | | | Poly- |
| | OMG | 20° C. | G′ | σ* | Tₘ | ΔHₘ | Eq.D | EqD | L/W | morphic |
| | (%) | (%) | (MPa) | (Pa) | (° C.) | (J/g) | (μm) | (nm) | ratio | form |
| CONTROL | 2.8 | 36.7 | 1.0 | 835 | 50.52 | 44.95 | 2.35 | 247 | 4 | β′ |
| 40:60 ABC | 1.4 | 35.72 | 4.4 | 1075 | 62.93 | 75.02 | 1.43 | 215 | 2.5 | β |
| 30:70 AB | 2.0 | 31.74 | 2.4 | 1191 | 61.69 | 66.39 | 1.64 | ND | ND | β |
| 30:70 ABC | 2.4 | 30.08 | 2.2 | 952 | 61.7 | 60.99 | 1.31 | 133 | 2.7 | β |
| 30:70 AB | 1.8 | 29.80 | 1.8 | 1095 | 60.98 | 61.90 | 1.19 | 116 | 2.8 | β |
| 1% GMS | | | | | | | | | | |
| 30:70 ABC | 2.9 | 28.66 | 1.7 | 1010 | 60.59 | 57.94 | 1.14 | 155 | 3.3 | β |
| 1% GMS | | | | | | | | | | |
| 30:70 ACB | 2.6 | 29.76 | 2.1 | 1292 | 61.03 | 58.73 | 1.13 | 105 | 3 | β |
| 1% GMS | | | | | | | | | | |
| 30:70 ABC | 3.1 | 30.84 | 1.8 | 891 | 56.48 | 34.39 | 1.29 | 180 | 2.4 | β |
| 1% GMP | | | | | | | | | | |
| 30:70 ACB | 3.8 | 30.24 | 1.9 | 789 | 54.96 | 35.56 | 1.57 | ND | ND | β |
| 1% GMP | | | | | | | | | | |
| 30:70 ABC | 7.9 | 29.4 | 1.3 | 557 | 55.53 | 28.00 | 0.86 | ND | ND | β |
| 1% Pchol. | | | | | | | | | | |
| 30:70 ACB | 7.1 | 29.85 | 1 | 603 | 54.72 | 30.63 | 0.86 | ND | ND | β |
| 1% Pchol. | | | | | | | | | | |
| 30:70 ABC | 5.8 | 29.06 | 1.2 | 614 | 57.64 | 31.02 | 0.95 | 152 | 2.4 | β |
| 1% BFP | | | | | | | | | | |
| 30:70 ABC | 6.9 | 30.07 | 1.3 | 658 | 55.17 | 33.82 | 0.89 | ND | ND | β |
| 1% BFP | | | | | | | | | | |

### Example 11

### Trans-Fat Content

On of the preferred embodiment is a composition comprising 29.5% FHSO, 69.5% SO, and 1% GMP. Provided in table 5 is a breakdown of the fatty acid composition of the preferred embodiment of FHSO:SO shortening product versus the commercially sold Bunge Shortening (APPS) as well as the fatty acid content of 3 emulsifiers, GMP, GMS, and BFP-75®. Within the table, “c” is cis, “t” trans, “tt” represents the fatty acid having 2 trans double bonds, and “n” represents an omega fatty acid.

As shown below, the trans-fat of the composition is 3.70% vs. 29.20% trans-fat for the control shortening (Bunge APPS). This reduced trans-fat content provides a trans-fat content of less than 0.5% per serving size and thus qualifies as a “zero trans-fats” product as defined by United States Food and Drug Administration guidelines. In addition, since the produced fat shortening has less than 5% of trans fatty acids it can be considered as an acceptable source trans fat free shortening (because the final product will contain less than 0.5% trans fat).

TABLE 5
Trans and Fatty Acid Composition (%) of various compositions.

| Fatty Acid | APPS (Control) | FHSO:SO | GMP | GMS | BFP ® |
|---|---|---|---|---|---|
| 14:00 | 0.20 | 0 | 1.25 | 0 | 0 |
| 16:00 | 12.35 | 11.08 | 57.39 | 11.16 | 11.50 |
| 16:1c9 | 0.07 | 0 | 0 | 0 | 0 |
| 17:00 | 0.18 | 0.12 | 0 | 0.25 | 0.30 |
| 18:00 | 18.20 | 25.75 | 38.21 | 87.57 | 86.40 |
| 18:1t4 | 0.02 | 0 | 0 | 0 | 0 |
| 18:1t5 | 0.27 | 0 | 0 | 0 | 0 |
| 18:1t6-8 | 0.48 | 0.09 | 0.12 | 0 | 0.03 |
| 18:1t9 | 3.37 | 0.13 | 0.24 | 0 | 0.05 |
| 18:1t10 | 4.19 | 0.28 | 0.42 | 0 | 0.11 |
| 18:1t11 | 6.40 | 0.36 | 0.06 | 0 | 0.04 |
| 18:1t12 | 3.18 | 0.10 | 0.23 | 0 | 0.05 |
| 18:1t13 | 4.42 | 0.16 | 0.11 | 0 | 0.05 |
| 18:1c6-10 | 20.65 | 13.63 | 1.22 | 0.11 | 0.23 |
| 18:1c11 | 2.42 | 1.07 | 0 | 0 | 0.05 |
| 18:1c12 | 6.71 | 0.79 | 0 | 0 | 0.08 |
| 18:1c13 | 0.91 | 0.19 | 0 | 0 | 0 |
| 18:1c14 | 0.29 | 0.12 | 0 | 0 | 0 |
| 18:2tt | 0.94 | 0 | 0 | 0 | 0 |
| 18:2t9&12 | 1.11 | 0.24 | 0 | 0 | 0.06 |
| 18:2c9t13 | 0.57 | 0.34 | 0 | 0 | 0.11 |
| t,t | 1.35 | 0.20 | 0 | 0 | 0 |
| 18:2c9-t12 | 1.61 | 0.41 | 0 | 0 | 0 |
| 18:2t9c12 | 1.29 | 0.33 | 0 | 0 | 0 |
| 18:2n6 | 6.92 | 35.32 | 0.25 | 0 | 0.06 |
| 18:2c9c15 | 0.87 | 0 | 0 | 0 | 0 |
| 20:00 | 0.42 | 0.28 | 0.50 | 0.58 | 0.58 |
| 18:3n6 | 0 | 0.15 | 0 | 0 | 0 |
| 20:1c11 | 0 | 0 | 0 | 0 | 0 |
| 18:3n3 | 0.31 | 4.88 | 0 | 0 | 0 |
| 18:2tt CLA | 0 | 1.06 | 0 | 0 | 0 |
| 22:00 | 0.33 | 0.24 | 0 | 0.33 | 0.3 |
| 24:00 | 0 | 1.21 | 0 | 0 | 0 |
| 22:5n3 | 0 | 1.46 | 0 | 0 | 0 |
| Trans fat content | 29.20 | 3.70 | 1.18 | 0 | 0.50 |

### Example 12

### Method of Preparation of Croissants

The following is example of appropriate amounts of each ingredient to be included into the method of preparation of croissants: bread flour (1.5 kg), salt (0.03 kg), granulated sugar (0.05 kg), cold milk (1 kg), yeast (0.085 kg), butter (0.2 kg) and roll-in shortening (such as the one described in Example 11, 0.4 kg).

In order to prepare the croissants, place bread flour, salt, and granulated sugar in a 30 qt. mixing bowl. Dissolve yeast in cold milk and add to the ingredients in the mixing bowl. Mix with a dough hook for 2 minutes on low and 4 minutes on 2^{nd} speed. Place the dough on a paper lined baking sheet, dusted with flour and spread the dough over the baking sheet before placing in the freezer for 30 minutes. Blend the butter and roll-in shortening together and roll the blended mixture into the dough. Give the dough three single folds, resting the dough for 30 minutes in the fridge between folds. Roll the dough to 18″×36″ and give dough one three fold (first single fold). Rest the dough in the refrigerator for 15 minutes. Roll the dough to 18″×36″ and give the dough one three fold (second single fold). Rest the dough in the refrigerator for 15 minutes. Roll the dough to 18″×36″ and give the dough one three fold (third single fold). When the dough is cold and relaxed, roll about 3 mm thick into a rectangular shape 60 cm wide and 100 cm long. Cut the dough lengthwise into 3-20 cm strips and divide strips into triangles. Make a 2 cm cut in the top center of the triangle and roll into a tight roll while stretching the dough. Place the croissants on a paper lined baking sheet. Egg wash the croissants 2 times, allowing time for the croissants to dry between application of egg washes. Proof and bake at 425° C.

This method can be modified as would be known by one skilled in the art such as a baker.

### Example 14

### Method of Preparation of Danishes

The following is example of appropriate amounts of each ingredient to be included into the method of preparation of Danishes: granulated sugar (9 ozs), salt (1 oz), skim milk powder (5 ozs), cinnamon (14 ozs), shortening (8 ozs), eggs (1 lb 2 ozs), cold water (2 lbs 2 ozs), yeast (6 ozs), bread flour (3 lbs 8 ozs), pastry flour (1 lb 8 ozs) and roll in shortening (such as the one described in Example 11, 2 lbs 7 ozs) for a total weight of 12 lbs 8 ozs.

In order to prepare the Danishes, blend sugar, salt, skim milk powder, cinnamon, and shortening for 2 minutes in a 23 L bowl on 2^{nd} speed using a dough hook or paddle. Add eggs gradually on low speed. Dissolve yeast in water and add to mix. Blend for 1 minute. Add bread flour and pastry flour and blend for 1 minute on low speed. Scrape the sides of the bowl and continue mixing for 30 seconds on 2^{nd} speed. Place the dough on a paper lined sheet pan which has been dusted with flour. Cover the dough and rest it for 30 minutes at low temperature (−4° C.). Roll the dough into a rectangular shape 30 cm×60 cm. Spread roll in shortening over two thirds of the dough. Fold the uncovered dough over one third of the fat covered dough, brush the flour off the dough, and fold the remaining fat covered dough over the rest of the dough. Roll the dough 45 cm×90 cm and give the dough one three fold (first single fold). Rest at low temperature for 15 minutes. Roll the dough 45 cm×90 cm and give the dough one three fold (second single fold). Rest the dough at low temperature for 15 minutes. Roll the dough 45 cm×90 cm and give the dough one three fold (third single fold). Allow the dough to rest for 2 to 24 hours at low temperature (1-2° C.). The dough should be covered with a plastic sheet. Roll half of the Danish dough which is cut crosswise into a rectangular shape 48″×18″. Roll the rectangle into a tight roll and cut into pieces. Twist the cut strips and form into a round Danish shape. Give full proof. Top with fruit and bake at 400° F. Bake the danishes until they reach a golden color.

This method can be modified as would be known by one skilled in the art such as a baker.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

1. A shortening composition comprising:
(a) between about 8.500 to about 39.995% (w/w) of a fully hydrogenated oil;
(b) between about 58.500 to about 89.995% of an oil; and
(c) between about 0.01 to about 3% of an emulsifier;
wherein the shortening composition has less than 5% trans fatty acids and the crystals of the shortening composition exhibit a beta polymorphism.

2. The shortening composition of claim 1 having between about 18.500 to about 39.995% of the fully hydrogenated oil.

3. The shortening composition of claim 1 having between about 29.500 to about 29.995% of the fully hydrogenated oil.

4. The shortening composition of claim 1, wherein the fully hydrogenated oil is a fully hydrogenated vegetable oil.

5. The shortening composition of claim 4, wherein the fully hydrogenated vegetable oil is selected from the group consisting of a fully hydrogenated soybean oil, a fully hydrogenated cottonseed oil, a fully hydrogenated canola oil, a fully hydrogenated sunflower oil, a fully hydrogenated safflower oil, a fully hydrogenated colza oil, a fully hydrogenated corn oil, a fully hydrogenated peanut oil, a fully hydrogenated olive oil, a fully hydrogenated microalgae oil and a fully hydrogenated rice bran oil.

6. The shortening composition of claim 4, wherein the fully hydrogenated vegetable oil is a fully hydrogenated soybean oil.

7. The shortening composition of claim 1, wherein the fully hydrogenated oil is a fully hydrogenated fish oil.

8. The shortening composition of claim 1 having between about 58.500 to about 79.995% of the oil.

9. The shortening composition of claim 1 having between about 68.500 to about 69.995% of the oil.

10. The shortening composition of claim 1, wherein the oil is a vegetable oil or a fish oil.

11. The shortening composition of claim 10, wherein the vegetable oil is selected from the group consisting of a soybean oil, a cottonseed oil, a canola oil, a sunflower oil, a safflower oil, a colza oil, a corn oil, a peanut oil, an olive oil, a microalgae oil and a rice bran oil.

12. The shortening composition of claim 10, wherein the vegetable oil has a high oleic acid content.

13. The shortening composition of claim 12, wherein the vegetable oil is selected from the group consisting of a high oleic-low linoleic/linolenic sunflower oil, a high oleic-low linoleic/linolenic canola oil, a high oleic-low linoleic/linolenic soybean oil, a high oleic-low linoleic/linolenic safflower oil, a high oleic-low linoleic/linolenic microalgae oil and a high oleic-low linoleic/linolenic sunflower oil.

14. The shortening composition of claim 10, wherein the vegetable oil is a soybean oil.

15. (canceled)

16. The shortening composition of claim 1 having about 3% of the emulsifier.

17. The shortening composition of claim 1 having about 1% of the emulsifier.

18. The shortening composition of claim 1, wherein the emulsifier is selected from the group consisting of sorbitan monostearate, polyoxyethylenesorbitan monostearate, glyceryl monopalmitate, sorbitan monopalmitate, sodium stearoyl lactylate, phosphatidylcholine and a combination of mono- and di-glycerides from an hydrogenated palm.

19. The shortening composition of claim 1, wherein the emulsifier is glyceryl monopalmitate.

20. The shortening composition of claim 1 having about 29.500% of the fully hydrogenated oil, about 69.500% of the oil and about 1% of the emulsifier, wherein the fully hydrogenated oil is a fully hydrogenated soybean oil, the oil is a soybean oil and the emulsifier is glyceryl monopalmitate.

21. A process for making the shortening composition defined in any one of claims 1 to 20, said process comprising:
(a) providing a first mixture comprising (i) between about 8.500 to about 39.995% (w/w) of a fully hydrogenated oil; (ii) between about 58.500 to about 89.995% of an oil; and (iii) between about 0.01 to about 3% of an emulsifier;
(b) adjusting, under agitation, the temperature of the first mixture to between about −5° C. to about 20° C. to obtain a second mixture; and
(c) adjusting the temperature of the second mixture to between about 8° C. to 15° C.

22.-32. (canceled)
